(19) United States
(12) Patent Application Publication
(10) Pub. No.: US 2003/0095580 A1
(43) Pub. Date: May 22, 2003

(54) Beam delivery system for lithographic exposure radiation source

(76) Inventors: Sergei V. Govorkov, Boca Raton, FL (US); Klaus Wolfgang Vogler, Goettingen (DE); Frank Voss, Bad Gandersheim (DE); Gongxue Hua, Coral Springs, FL (US); Rainer Paetzel, Dransfeld (DE)

Correspondence Address: Andrew V. Smith, Sierra Patent Group, P.O. Box 6149, Stateline, NV, 89449, US

(21) Appl. No.: 10/267,002

(22) Filed: Oct. 7, 2002

Related U.S. Application Data
(63) Continuation-in-part of application No. 09/965,492, filed on Sep. 26, 2001, now Pat. No. 6,487,229.
Application No. 09/965,492 is a division of application No. 09/594,892, filed on Jun. 14, 2000, now Pat. No. 6,327,290.
Application No. 09/594,892 is a continuation-in-part of application No. 09/343,333, filed on Jun. 30, 1999, now Pat. No. 6,219,368.
(63) Continuation-in-part of application No. 09/971,796, filed on Oct. 3, 2001, now Pat. No. 6,463,084.
Application No. 09/971,796 is a division of application No. 09/598,552, filed on Jun. 21, 2000, now Pat. No. 6,442,182.
(60) Provisional application No. 60/119,973, filed on Feb. 12, 1999.
(60) Provisional application No. 60/140,530, filed on Jun. 23, 1999.
(60) Provisional application No. 60/119,973, filed on Feb. 12, 1999.

(51) Int. Cl. H01S 3/22

(52) U.S. Cl. 372/57

(57) ABSTRACT

A system is provided for delivering a lithographic exposure radiation source beam of wavelength less than 200 nm from a lithographic exposure radiation source through a sealed enclosure preferably sealably connected to the lithographic exposure radiation source, and preferably to another housing, leading ultimately to a workpiece. The enclosure is preferably evacuated and back-filled with an inert gas to adequately deplete any air, water, hydrocarbons or oxygen within the enclosure. Thereafter or alternatively, an inert gas flow is established and maintained within the enclosure during operation of the lithographic exposure radiation source. Also, alternatively, the enclosure may be evacuated and no inert gas flowed. The inert gas preferably has high purity, e.g., more than 99.5% and preferably more than 99.999%, wherein the inert is preferably nitrogen or a noble gas. The enclosure is preferably made of steel and/or copper.

### PRIORITY

This Application is a continuation-in-part (CIP) of U.S. patent application Ser. No. 09/965,492, filed Sep. 26, 2001, as being drawn to non-elected species in the '492 application, which is a divisional of 09/594,892, filed Jun. 14, 2000, now U.S. Pat. No. 6,327,290, which is a CIP of 09/343,333, filed Jun. 30, 1999, now U.S. Pat. No. 6,219,368, which claims the benefit of priority to U.S. Provisional Patent Application No. 60/119,973, filed Feb. 12, 1999, and

the application is further a CIP of U.S. patent application Ser. No. 09/971,796, field Oct. 8, 2002, as being drawn to non-elected species in the '796 application, which is a divisional of 09/598,522, filed Jun. 21, 2000, which claims the benefit of priority to 60/140,530, filed Jun. 23, 1999, and is a CIP of 09/343,333, filed Jun. 30, 1999, now U.S. Pat. No. 6,219,368, which claims the benefit of priority to U.S. Provisional Patent Application No. 60/119,973, filed Feb. 12, 1999, and

each of the above is hereby incorporated by reference into the present application.

### BACKGROUND OF THE INVENTION

1. Field of the Invention

The present invention relates to a beam delivery system for use with lithographic exposure radiation sources, e.g., such as molecular fluorine lasers emitting around 157 nm, and to on-line control of the output power of a lithographic exposure radiation source beam, and particularly to a technique for redirecting sub-200 nm light of the beam to a detector.

2. Discussion of the Related Art

Molecular fluorine (F₂) lasers operating at a wavelength of approximately 157 nm are a likely choice for deep UV/vacuum UV microlithography with resolution below 0.1 micrometer. The molecular fluorine laser emitting at 157 nm has an advantageously short wavelength, or high photon energy. Because of this, very small structures, such as sub-0.18 micron structures and even sub-0.10 micron structures, may be formed by photolithographic exposure on semiconductor substrates. TFT annealing and micro-machining applications may also be performed advantageously at this wavelength. Lithographic exposure radiation source radiation at this wavelength is also very useful for micromachining applications involving materials normally transparent at commonly available lithographic exposure radiation source wavelengths.

Efficient extracavity transport of a sub-200 nm beam to the target is complicated by strong absorption in the atmosphere. That is, the sub-200 nm beam of such a lithographic exposure radiation source will propagate a certain distance along an extracavity beam path between the lithographic exposure radiation source output and a work piece where it is subject to absorptive losses due to any photoabsorbing species such as water, oxygen and hydrocarbons located along the beam path. For example, an extinction length (1/e) for 157 nm radiation emitted by the F₂-laser is less than a millimeter in ambient air.

High intracavity losses also occur for lithographic exposure radiation sources operating at wavelengths below 200 nm , again due particularly to characteristic absorption by oxygen and water, but also due to scattering in gases and all optical elements. As with the absorption, the short wavelength (less than 200 nm) is responsible for high scattering losses due to the wavelength dependence of the photon scattering cross section.

These complications from absorption and scattering are much less of a problem for conventional lithography systems employing 248 nm light, such as is emitted by the KrF-excimer lithographic exposure radiation source. Species such as oxygen and water in the cavity and atmosphere which absorb strongly below 200 nm, and specifically very strongly around 157 nm for the F₂ laser, exhibit negligible absorption at 248 nm. The extinction length in ambient air for 248 nm light is substantially more than ten meters. Also, photon scattering in gases and optical elements is reduced at 248 nm compared with that occurring at shorter wavelengths. In addition, output beam characteristics are more sensitive to temperature-induced variations effecting the production of smaller structures lithographically at short wavelengths such as 157 nm, than those for longer wavelength lithography at 248 nm. Clearly, KrF excimer lithographic exposure radiation sources do not have the same level of problems since the 248 nm light scatters less and experiences less absorption.

One possible solution for dealing with the absorption problems of the 157 nm emission of the F₂ laser source is sealing the beam path with a housing or enclosure and purging the beam path with an inert gas. High flow rates are typically used in this technique in order to minimize the down time needed to remove absorbing species from the beam enclosure. It may also be necessary to perform this purging technique with a very clean inert gas, e.g., containing less than 1 ppm of absorbing species such as water and oxygen. Commercial ultra high purity (UHP) grade gases may be obtained to satisfy these purity requirements at increased cost.

Another solution would be evacuating the beam path. In this case, a relatively low pressure vacuum would be needed resulting in an expensive pumping system. For example, ultrahigh vacuum (UHV) pumping equipment and techniques may be necessary for achieving a pressure below 100 millitorr. Such equipment and techniques combine a tight enclosure with high pumping capacity. In this evacuation approach, transmission along the optical beam path enclosure would be determined by the absorption of radiation by “residual” gases, mainly oxygen, water vapor and hydrocarbons which remain despite the evacuation, e.g., particularly attached to the interior walls of the enclosure.

FIG. 1 shows an experimentally measured dependence of the transmission of a 0.5 meter optical path on the residual air pressure. A theoretical fit is also shown in FIG. 1 and is based on the assumption that the main absorbing species is water vapor having an absorption cross-section of approximately 3×10⁻¹⁸ cm². This assumption is believed to be justified because water has a tendency to be adsorbed at the walls of vacuum systems and thus, to dominate the residual pressure in such systems.

As can be seen, at a residual pressure of 50 milliTorr, the optical losses amount to about 1% per each 0.5 meter of the optical path. At around 100 milliTorr, the optical losses amount to about 2% per each 0.5 meter. At 150 milliTorr and 200 milliTorr, respectively, the losses amount to 3% and 4.5%. In a system such as a microlithographic stepper, the optical beam path can be as large as several meters which would lead to an unsatisfactorily high total amount of losses at that loss rate. For example, an average five meter beam path, even at a transmittance between 99% and 95.5%, as shown for 50-200 milliTorr residual pressures in FIG. 1, corresponds to between a 10% and 37% loss.

Another consideration is the energy stability. It is desired to maintain lithographic exposure radiation source energy dose variations, and/or energy moving average variations, to less than, e.g., 0.5%. If residual oxygen or water vapor partial pressures fluctuate by 0.5% to 1.0%, e.g., then fluctuations in the absorption of the beam by these species could cause the energy dose stability to fall below desired or even tolerable levels. It is recognized in the present invention that a first step of lowering the partial pressures of photoabsorbing species along the lithographic exposure radiation source beam path would serve to lower the % absorption fluctuation and increase the energy dose stability, even if the % concentrations of these species fluctuate at the same % value. It is desired, then, to have a technique for preparing the beam path of a sub-200 nm lithographic exposure radiation source such that absorption and absorption fluctuations of the beam along the beam path are low enough to meet energy dose stability criteria, e.g., of <0.5%.

It is clear from the above measurement and theoretical fit for the beam path evacuation technique that one needs to lower the residual pressure of the absorbing species substantially below 100 milliTorr to achieve acceptable optical losses, e.g. less than around 1% per meter of optical path length, and acceptable optical loss fluctuations. Such low pressures can only be obtained using complex and expensive vacuum equipment and/or operating the vacuum equipment for an unacceptably long time. All together, this leads to a substantial and undesirable downtime for pumping and requires complex and expensive equipment. An approach is needed for depleting the beam path of a lithographic exposure radiation source operating below 200 nm, particularly an F₂ lithographic exposure radiation source, of photoabsorbing species without incurring excessive down times or costs.

It is recognized in the present invention that photoabsorbing species may tend to accumulate in greater concentrations along a beam path of a sub-200 nm lithographic exposure radiation source beam than would otherwise accumulate along a similar length, e.g., of an enclosure otherwise substantially free of photoabsorbing and/or other contaminant species. This contamination generation has been observed experimentally to occur along the beam path from a VUV laser source to an imaging system, workpiece, or other external application process equipment. It is desired that such photoabsorbing and/or other contaminant species be prevented from exiting the enclosure and contaminating another environment, such as a housing connected to the enclosure which may contain an imaging system and/or workpiece.

Moreover, for the applications mentioned above, on-line monitoring and control of the output power of the laser may be advantageously performed such that the energy stability of the output beam and overall performance of the laser may be enhanced. For this purpose, an energy or power detector may be configured to receive a split off portion of the output beam. The input voltage and other conditions such as the gas mixture composition may be actively adjusted depending on the measured pulse energy, energy dose or moving average energy in order to provide high stability.

There are several factors inhibiting use of conventional light detectors for on-line monitoring of VUV laser output. First, laser radiation below 200 nm is strongly absorbed in the atmosphere, e.g., by water vapor, oxygen, hydrocarbons, and fluorocarbons. Specifically, at 157 nm, the extinction length of a molecular fluorine laser beam is around 1 mm or less in ambient air due mostly to the presence of oxygen and water vapor in the air. Second, contaminants such as oil vapors and other organic substances generated, for instance, by vacuum pumps and plastic enclosures tend to form films on optical surfaces causing strong absorption. Third, the molecular fluorine laser generates, in addition to 157 nm light, radiation in the red part of the visible spectrum, between 600 and 800 nm, due to emission by excited atomic fluorine species in the laser gas mixture. This red emission is sensed by most optical detectors whose sensitivity tends to be higher in the visible part of the spectrum, as compared to that in the VUV range, i.e., at 157 nm.

### SUMMARY OF THE INVENTION

In view of the above, a beam delivery system for delivering a lithographic exposure radiation source beam including a wavelength less than 200 nm to an external housing leading ultimately to a workpiece is provided including an enclosure separating at least a portion of the beam path exiting the lithographic exposure radiation source from the outer atmosphere; and one or more ports for evacuating the enclosure and removing sub-200 nm photoabsorbing species therefrom and maintaining said beam path substantially free of sub-200 nm photoabsorbing species to enable the beam to propagate along said beam path, such that the energy of the beam can traverse said enclosure without substantial attenuation due to the presence of photoabsorbing species along said beam path.

A beam delivery system for delivering a lithographic exposure radiation source beam including a wavelength less than 200 nm to an external housing leading ultimately to a workpiece is also provided, including an enclosure separating at least a portion of the beam path exiting the exposure radiation source from the outer atmosphere; and one or more ports for evacuating the enclosure and flowing an inert gas of greater than 99.5% purity within said enclosure and maintaining said beam path substantially free of sub-200 nm photoabsorbing species to enable the beam to propagate along said beam path, such that the energy of the beam can traverse said enclosure without substantial attenuation due to the presence of photoabsorbing species along said beam path.

A method of delivering a sub-200 nm lithographic exposure radiation portion from a main beam which is generated by a lithographic exposure radiation source for use at an application process to a detector for monitoring a parameter of the beam is also provided including sealing off a beam path within an enclosure optically coupled with the detector; preparing the interior of the enclosure for transmitting the main beam and the sub-200 nm lithographic exposure radiation portion for delivery to the detector such that said interior is substantially free of sub-200 nm photoabsorbing species, and wherein said exposure radiation portion that is delivered to the detector is directed along a beam path within said enclosure and is thereby protected from being substantially attenuated by said sub-200 nm photoabsorbing species; separating said exposure radiation portion for delivery to the detector from the main beam; and detecting the exposure radiation portion separated from said main beam at said separating step and delivered to the detector along said beam path and not substantially attenuated by said sub-200 nm photoabsorbing species.

A method of delivering sub-200 nm lithographic exposure radiation which is generated by a lithographic exposure radiation source for use at an application process is also provided including sealing off a beam path of the sub-200 nm lithographic exposure radiation within an enclosure; preparing an interior of the enclosure for transmitting the exposure radiation such that said interior is substantially free of sub-200 nm photoabsorbing species, and wherein said exposure radiation is directed along a beam path within said enclosure and is thereby protected from being substantially attenuated due to the presence of said sub-200 nm photoabsorbing species, and wherein said exposure radiation is thereby directed along said beam path within said enclosure and not substantially attenuated by said sub-200 nm photoabsorbing species.

A method of delivering sub-200 nm lithographic exposure radiation which is generated by a lithographic exposure radiation source for use at an application process is also provided including sealing off a beam path of the sub-200 nm lithographic exposure radiation within an enclosure; disposing at least one optical element within said enclosure; preparing an interior of the enclosure for transmitting the exposure radiation such that said interior is substantially free of contaminant species, and wherein said exposure radiation is directed along a beam path within said enclosure and is thereby protected from being substantially disturbed by said contaminant species; and interacting said exposure radiation with said at least one optical component within said enclosure, wherein said exposure radiation is thereby directed along said beam path within said enclosure and not substantially disturbed by said contaminant species.

### BRIEF DESCRIPTION OF THE DRAWINGS

FIG. 1 shows a dependence of the transmittance of a 157 nm beam propagating along a 0.5 m evacuated beam path on the residual air pressure along the beam path.

FIG. 2 shows a first embodiment of a beam delivery system for a sub-200 nm lithographic exposure radiation source including an enclosure providing an inert gas purged beam path.

FIG. 3 shows a dependence of the transmittance of a 157 nm beam propagating along a 0.5 m beam path purged with helium or nitrogen gas on the number of flushings of the beam path using each of the two inert gases.

FIG. 4a shows a preferred embodiment of a beam delivery system for a lithographic exposure radiation source emitting at less than 200 nm, including an enclosure sealed with a transparent window providing an inert gas purged beam path.

FIG. 4b shows an experimental setup, and also an alternative embodiment when the detector P is replaced by an external housing including an optical imaging system of a photolithography system and/or a workpiece.

FIG. 5 shows data of spectral absorption data for selected species.

FIG. 6 shows the effect of switching the lithographic exposure radiation source off on the level of O₂ along a purged beam path according to the preferred embodiment.

FIG. 7 shows the effect of switching the lithographic exposure radiation source back on on the level of O₂ along the purged beam path of the preferred embodiment.

FIG. 8 shows the rate at which an inert gas purged beam path returns to low contamination level after flushing the beam path with O₂.

FIG. 9 shows the rate at which an inert gas purged beam path returns to low contamination level after flushing the beam path with ambient air.

FIG. 10 shows a first pair of overlaying plots of O₂ concentration in a purged VUV lithographic exposure radiation source beam path and lithographic exposure radiation source power versus time, illustrating how the O₂ concentration depends on the lithographic exposure radiation source power.

FIG. 11 shows a second pair of overlaying plots of O₂ concentration in a purged VUV lithographic exposure radiation source beam path and lithographic exposure radiation source power versus time, illustrating how the O₂ concentration depends on the lithographic exposure radiation source power.

FIG. 12 shows plots of the dependence of oxygen concentration in the enclosure of FIG. 4b on the purge gas flow rate for argon and nitrogen purge gases with and without the lithographic exposure radiation source turned on.

FIG. 13 shows plots of the dependence of oxygen concentration in the enclosure of FIG. 4b on the lithographic exposure radiation source power for nitrogen purge gas at 5.3 W lithographic exposure radiation source power for various purge gas flow rates.

FIG. 14 shows plots of the dependence of generated oxygen concentration in the enclosure of FIG. 4b on the purge gas flow rate for nitrogen purge gas with the lithographic exposure radiation source on.

FIG. 15 schematically illustrates a molecular fluorine laser system in accord with a preferred embodiment.

FIG. 16 schematically illustrates a beam path enclosure in accord with a first preferred embodiment.

FIG. 17 shows plots of measured laser output power versus time for a molecular fluorine laser system including a beam path enclosure having an evacuated interior and an enclosure purged with a steady flow of inert gas in accord with a preferred embodiment.

FIG. 18 schematically illustrates a beam path enclosure in accord with a second preferred embodiment.

FIG. 19 schematically illustrates a beam path enclosure in accord with a third preferred embodiment.

FIG. 20 schematically illustrates a beam path enclosure in accord with a fourth preferred embodiment.

FIGS. 21a and 21b schematically illustrate alternative beam splitter configurations to the first and third preferred embodiments of FIGS. 16 and 19, respectively.

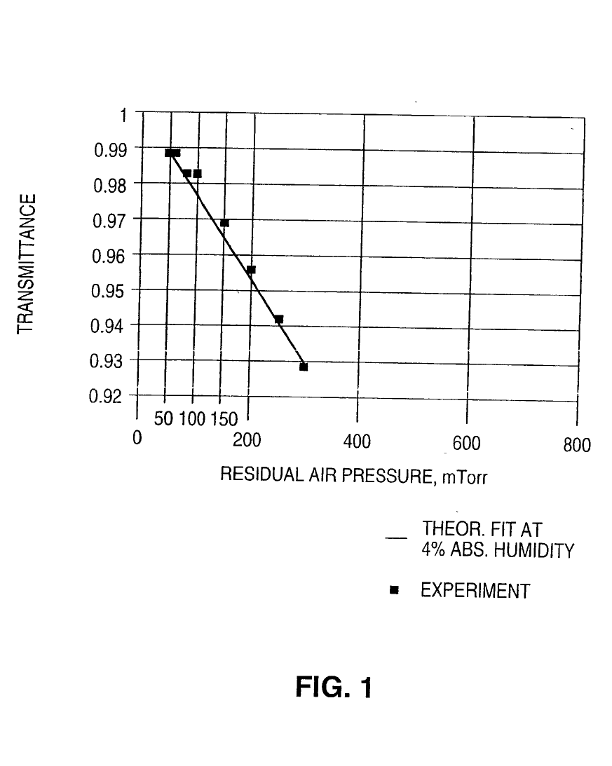

### DETAILED DESCRIPTION OF THE PREFERRED EMBODIMENTS

Among the preferred embodiments, a lithographic exposure radiation source system is described wherein a beam path of the lithographic exposure radiation source beam exiting the lithographic exposure radiation source is substantially depleted of species which photoabsorb strongly below 200 nm including such species as air, water, oxygen and hydrocarbons. A system is described wherein contaminants generated along a beam path of the lithographic exposure radiation source beam exiting the lithographic exposure radiation source are flushed from the beam path and/or prevented from crossing from the beam path into an external enclosure, while the beam is allowed to propagate into the external enclosure.

A beam delivery system is further described for connecting to a lithographic exposure radiation source emitting a lithographic exposure radiation source beam at less than 200 nm and for delivering the lithographic exposure radiation source beam to an external housing leading ultimately to a workpiece is provided. The system includes an enclosure sealing at least a portion of the beam path exiting the lithographic exposure radiation source from the outer atmosphere, the enclosure includes a plurality of ports for flowing an inert gas, of preferably 99.5% purity or more, within the enclosure to enable the lithographic exposure radiation source beam to propagate along the beam path, such that the energy of the beam can traverse enclosure without substantial attenuation due to the presence of photoabsorbing species along the beam path. A window preferably seals the enclosure that is substantially transparent at the emission wavelength of less than 200 nm to allow the beam to exit the enclosure and enter the external housing, while preventing contaminants generated within the enclosure from exiting the enclosure and contaminating surfaces within the housing.

Propagation with significant transmittance of the 157 nm emission of a molecular fluorine (F₂) lithographic exposure radiation source along the beam path is specifically described, as well as for ArF, Xe, Kr, Ar, and H₂ lithographic exposure radiation sources operating respectively at 193 nm, 172 nm, 145 nm, 125 nm and 121 nm . Absorption and absorption fluctuations are advantageously maintained at a low level within the enclosure for greater efficiency, energy stability and energy dose stability. The sub-200 nm beam is allowed to propagate along the beam path within the enclosure, and then to exit the enclosure, preferably into a second enclosure such as may include an optical imaging system of a photolithography system, leading ultimately to a workpiece, while contaminants generated within the enclosure are prevented from exiting the enclosure due to the presence of the window sealing the enclosure.

A beam delivery system for a lithographic exposure radiation source emitting at a relevant wavelength of less than 200 nm is also described. The system includes a sealed enclosure surrounding the path of the beam as it exits the radiation source. The enclosure extends between the output and a photodetector sensitive at the wavelength of the relevant emission. The interior of the enclosure, and thus the beam path between the output and the detector, is substantially free of species that strongly photoabsorb radiation at the relevant laser emission wavelength. A beam splitting element diverts at least a portion of the beam for measurement by the detector.

The beam splitting clement preferably includes a beam splitting mirror, holographic beam sampler or diffraction grating. In addition, particularly for the molecular fluorine laser, optics are preferably provided for filtering a visible portion of the diverted beam, so that substantially only a VUV portion of the diverted beam is received at the detector. The filtering optics preferably include a diffraction grating, holographic beam sampler or dichroic mirrors.

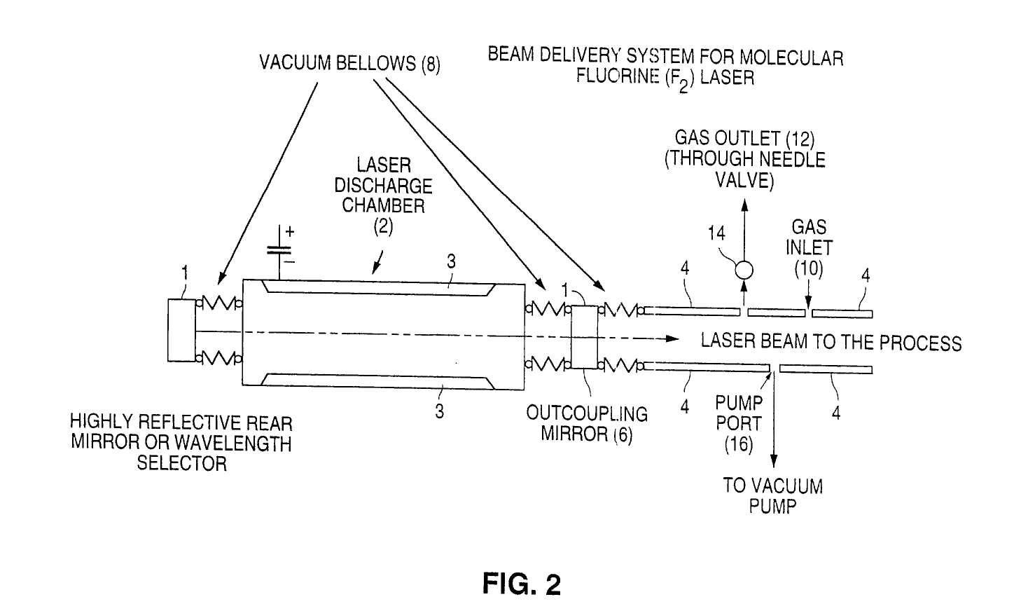

FIG. 2 shows a preferred embodiment of a beam delivery system for the present invention. The present invention may be used with any lithographic exposure radiation source, but is particularly advantageous for a lithographic exposure radiation source operating below 200 nm such as ArF, Xe, F₂, Kr, Ar and H₂ lithographic exposure radiation sources operating around 193 nm, 172 nm, 157 nm, 145 nm, 125 nm and 121 nm, respectively. A F₂ laser as lithographic exposure radiation source system operating around 157 nm will be specifically referred to in the preferred embodiment below. Resonator optics 1 are preferably mounted to a laser discharge chamber 2 or tube in such a manner that their tilt can be adjusted, in order to align them to the optical axis of the resonator 1. Preferred optical and electrical systems are described in greater detail in U.S. Patent Application Ser. Nos. 09/090,989 and 09/136,353 and U.S. Provisional Application No. 60/120,218, each of which is hereby incorporated into the present application by reference. For example, means for selecting one of the closely-spaced natural emission lines around 157 nm of the F₂ laser is part of the preferred optics.

A pair of main electrodes 3 is connected to an external power supply circuit to supply a pulsed discharge to excite the molecular fluorine in the gas mixture. In addition, UV-preionization of the electrical discharge is also provided and may be realized by means of an array of spark gaps or by another source of UV-radiation (surface, barrier or corona gas discharges), disposed in the vicinity of at least one of the main electrodes 3 of the main discharge of the laser. A preferred preionization unit is described in U.S. patent application Ser. No. 09/247,887 which is also hereby incorporated by reference into this present application.

A housing or enclosure 4 containing the beam path is attached to an outcoupling mirror holder 6 of the resonator optics 1 preferably through vacuum bellows 8 and sealed with conventional o-rings (such as Viton™ o-rings), flat packing or other sealing materials. This allows degrees of freedom necessary for optical alignment of the outcoupling mirror 6, while at the same time maintaining a vacuum-quality seal between the outcoupler 6 and the beam path enclosure 4. The residual pressure within the beam path enclosure 4 preferably may be reduced to less than 200 milliTorr, and specifically to 100 milliTorr or less.

The enclosure 4 is equipped with a purging gas inlet 10 and a gas outlet 12 and means for controlling the gas flow rate, such as an adjustable needle valve 14. If only one inlet 10/outlet 12 pair is used, the inlet 10 and outlet 12 are spaced apart and preferably located at opposed ends of the enclosure 4. A long beam delivery system will preferably have several pairs of gas inlets 10 and outlets 12. The inlets 10 and outlets 12 are preferably positioned to provide a homogeneous medium within the enclosure along the beam path. In this way, every section of the beam delivery system is sufficiently purged with low consumption of the purge gas. Even a short beam delivery system may have several gas inlets 10 and outlets 12 especially, e.g., if a clear aperture within the beam delivery system is blocked by built-in optical components and mounts. For example, the beam path may be partitioned with one or more optical windows.

The preferred vacuum level can be achieved by connecting a simple and inexpensive (e.g., 50 mTorr) one or two stage mechanical rotary vane or rotary piston pump or roughing pump (not shown) to the enclosure 4 via a pump port 16. The pump port 16 need not be a separate connection to the enclosure 4. For example, the vacuum source may use the inlet 10 or out let 12 connection to the enclosure 4 which may be sealed off from the pump when the inert gas is flowing, such as by a T-valve or some similar component.

Preferably, a 0.5 mbar 4-stage diaphragm pump is used. An oil vapor trap may be used between the pump and the beam path enclosure, such as a cryogenic trap or Micromaze [TM] filter. A three-stage diaphragm pump, which is relatively cheap and oil-free, can also be used. Alternatively, a more sophisticated pump or pumps may be used such as an oil diffusion pump, a cryogenic pump or a turbomolecular pump. The preferred “tightness” of the beam path enclosure 4 is equivalent to a leak rate of one Torr-liter per minute or lower. The purging gas is preferably ultra-high purity (UHP) grade helium, argon, or neon, although other inert gases (e.g., nitrogen) of UHP grade may also be used.

A preferred procedure of preparing the beam path enclosure 4 for operation of a lithographic exposure radiation source system of the present invention, and particularly for the F₂ laser as lithographic exposure radiation source emitting at 157 nm, is explained below. Note that the preferred lithographic exposure radiation source system includes a processor for controlling and coordinating various components. The procedure for preparing the beam path, in accord with the present invention, may be manually- or processor-controlled. If a processor is used, vacuum gauge and gas flow meter readings would be inputs. The processor would generate output signals for controlling the opening and closing of the pump port 16 and the purging gas inlet(s) 10 and outlet(s) 12 and the flow control of the valve 14.

The preferred method includes first, closing the gas inlet 10 and outlet 12. Second, opening the pump port 16, and pumping down the enclosure 4 with, e.g., a 50 milliTorr vacuum pump until the vacuum gauge indicates that a predetermined residual pressure has been reached within the enclosure 4, e.g., 100-200 milliTorr, or lower. In a preferred embodiment, the enclosure 4 is pumped down to around 0.5 Torr using a 3 or 4 stage diaphragm pump. Next, the pump port 16 is closed off, the inlet port 10 is opened and the enclosure 4 is filled with inert gas flowing in through the inlet port 10 until approximately atmospheric pressure or higher is reached in the enclosure 4. Then, the inlet port 10 is again closed and the pump port 16 opened to repeat the evacuation procedure. These steps of evacuating the enclosure 4 followed by back-filling the enclosure 4 with inert gas are preferably repeated several times.

After these several gas flushing cycles, the pump port 16 is closed and both the gas inlet 10 and gas outlet 12 are opened. A gas flow at a selected flow rate, preferably around 0.1 liters per minute, is established and maintained in the enclosure 4 through control of the flow control valve 14. The pressure is now maintained around atmospheric pressure or preferably slightly higher. The beam path enclosure is now ready for working operation of the lithographic exposure radiation source.

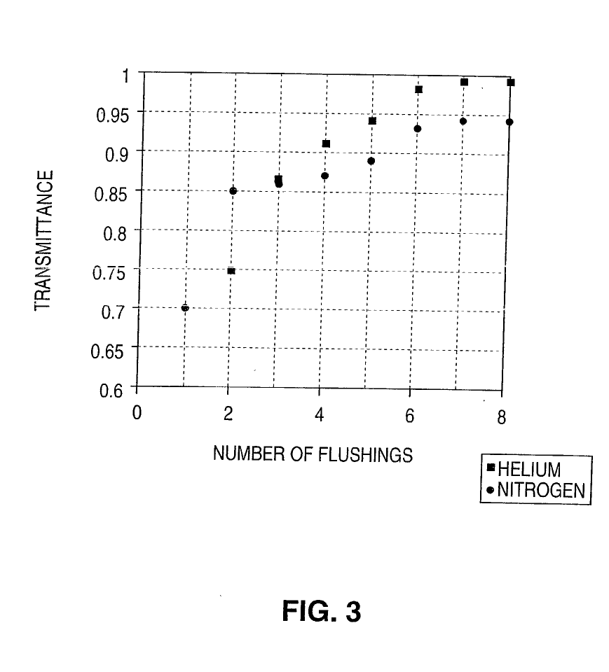

FIG. 3 shows that the transmittance of a 157 nm beam from an F₂ laser as lithographic exposure radiation source along a 0.5 meter long optical path using helium and nitrogen as flushing gases. The transmittance is shown as increasing with the number of flushes, but becomes asymptotic to its highest value in as few as eight (8) “flushing” cycles. Of course, more than eight flushing cycles may nonetheless be used. As can be seen, for helium, close to 99% transmittance can be achieved with eight flushes. The results using nitrogen were not as good as with helium. However, the nitrogen used in the experiments has a specified level of water of only 3 ppm, while UHP helium was much more pure and had a specified water level of less than 1 ppm which may have accounted for the difference in performance.

The present invention teaches that using cycles of evacuating and filling the enclosure 4 with inert gas allows drastically reduced preparation times and also minimizes inert gas consumption. After these flushing cycles are performed, a preferred flow rate of 0.1 liters per minute is sufficient to maintain high transmittance for a substantial period of time. The entire preparation cycle advantageously takes only a few minutes. In addition, relatively inexpensive pumps and lower cost sealing arrangements can be used.

In another aspect of the invention, it is recognized in the present invention that contaminants may be generated within the enclosure which may flow onto a workpiece that is being processed or exposed using the VUV lithographic exposure radiation source beam that is traversing the interior of the enclosure, or onto optical equipment. The contaminant generation rate is recognized as being related to the operation of the lithographic exposure radiation source, such as due to the interaction of the beam or stray light therefrom with components within the enclosure or the enclosure itself. It is further recognized in the invention that these contaminants may conventionally flow out of an opening at the end of the enclosure (see FIG. 2).

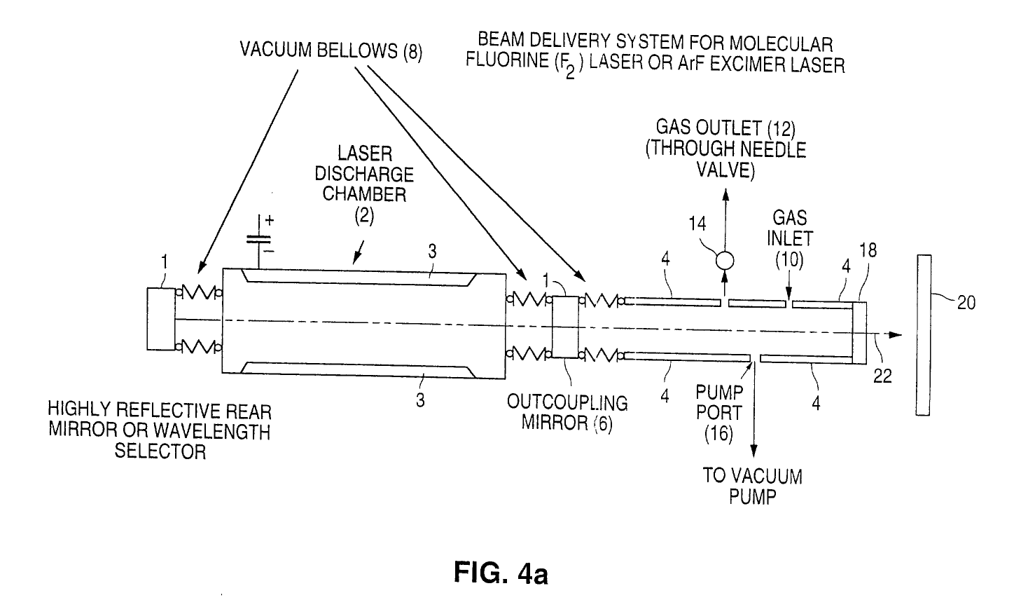

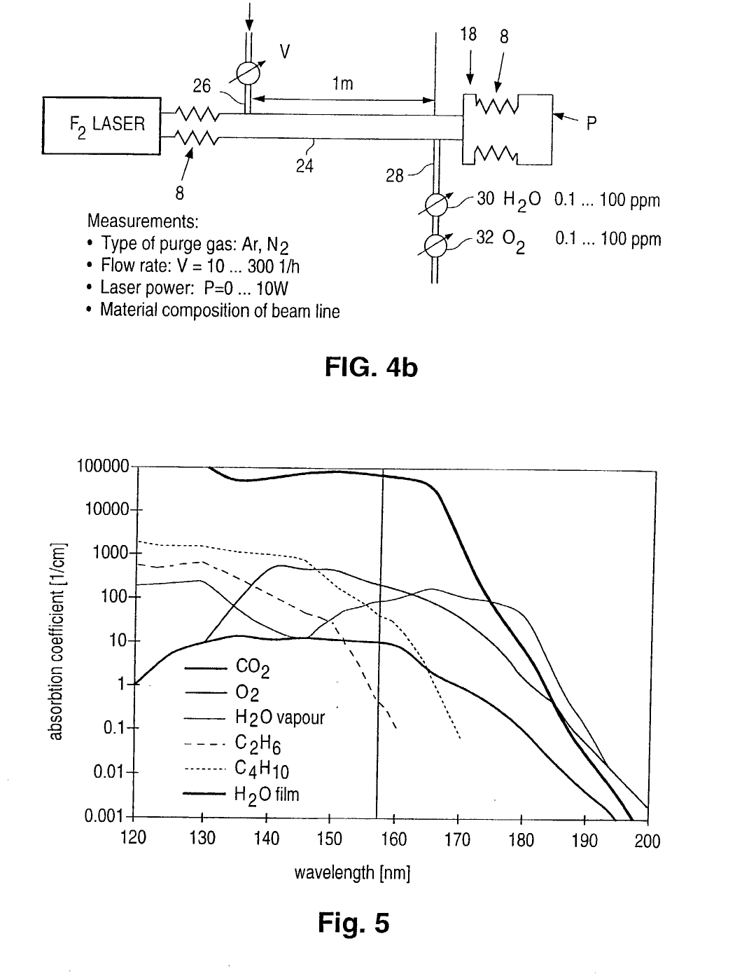

In accordance with the preferred embodiment, then, referring to FIG. 4a, a transparent window 18 is provided to seal the interior of the enclosure 4 from a workpiece 20, or other processing or beam shaping equipment, e.g., an optical imaging system, that the beam 22 may be directed towards. The window 18 is transparent to the light, and so for the F₂ laser the window is made of preferably CaF₂ and alternatively a material such as BaF₂, BaF, LiF, SrF₂, LiF₂, MgF₂, quartz and fluorine doped quartz, or another material that may be known to one skilled in the art as being substantially transparent to light around 157 nm . The window may have an antireflection coating on it, as well. Thus, the beam is allowed to escape the enclosure which protects the beam from attenuation, while contaminants generated within the enclosure are unable to escape and are thereby prevented from deteriorating a workpiece 20 or other processing or optical equipment.

The concerns addressed by this aspect of the invention wherein a window is included at the end of the beam path of the molecular fluorine VUV lithographic exposure radiation source system, are shown in more detail below as being verified by experimental results. The presence of the VUV beam is shown experimentally as providing an increase in the contamination level in the enclosure. For example, when a copper enclosure was used, a contamination level of O₂ was measured to be 0.5 ppm when the lithographic exposure radiation source was off, and 0.8 ppm when the lithographic exposure radiation source was on under otherwise identical conditions. A lithographic exposure radiation source running continuously for two days and having a stainless steel enclosure was shown to have an O₂ contamination level between 0.4 and 0.5 ppm, which fell to between 0.25 and 0.3 ppm when the lithographic exposure radiation source was switched off. The O₂ level increased back to between 0.45 and 0.55 ppm when the lithographic exposure radiation source was later switched back on.

Thus, particularly when the lithographic exposure radiation source is running, it is advantageous to have the window of the present invention to block impurities from exiting the enclosure and deteriorating a workpiece 20 or other processing equipment outside the enclosure 4. The workpiece 20 or other processing equipment such as optical imaging equipment, etc., may be protected by its own enclosure (not shown) which protects the workpiece 20, etc., from contaminants such as O₂, H₂O, hydrocarbons and dust in the atmosphere. This external enclosure (not shown) for the workpiece may be a clean room or a smaller housing. The external enclosure (not shown) may be sealably connected to the enclosure 4 at the window 18, whereby the window 18 seals the enclosure 4 from the enclosure (not shown). Thus, the enclosure 4 and the external enclosure (not shown) are optically and mechanically coupled together, although there is not fluid communication between the two enclosures. The window 18 advantageously prevents contaminants generated in the VUV lithographic exposure radiation source enclosure 4 from entering the external enclosure (not shown) for an imaging system and/or workpiece.

The window 18 itself may be kept clean by using a method of flowing very clean gas past the window to prevent contaminated gas from accessing the window and depositing a film that might absorb VUV light and attenuate the beam. The technique set forth in U.S. Pat. No. 4,534,034 (hereby incorporated by reference), whereby an electrostatic precipitator is used to clean some portion of gas before flowing that gas to a lithographic exposure radiation source tube window, may be used to keep the window 18 clean. In addition, a set of baffles and/or a precipitator may be positioned near the window 18 to trap contaminants and keep them from accessing the window 18.

It is recognized in the invention that the generated contaminants may also deteriorate the atmosphere within the enclosure such as to attenuate the VUV beam notwithstanding that the method of pumping and purging the interior of the enclosure with an inert gas as described above is in place. It is further recognized in the invention that the degree of contamination generated within the enclosure may depend on the materials that the enclosure is made of. Moreover, the particular pressure within the enclosure may effect the performance of the system. Lastly, the particular purge gas being used may enhance or reduce the performance or the benefits of the enclosure according to the above aspect of the invention. These features are not only recognized in the present invention as potentially effecting the system, but as described below, advantageous beam enclosures are provided in accordance with that recognition and in accordance with the preferred embodiment.

Experiments were performed in accordance with the features recognized as effecting the molecular fluorine lithographic exposure radiation source system and beam path enclosure 4 (see above). In accordance with the present invention, a system is provided that is improved based on results produced in experiments conducted with respect to that recognition.

FIG. 4b schematically illustrates the experimental setup used. FIG. 4b also illustrates alternative features to the embodiment shown at FIG. 4a, including an enclosure sealably connected to an F₂ lithographic exposure radiation source. The enclosure 24 has an inlet port 26 and an outlet port 28 for flowing the inert gas through the enclosure, and vacuum bellows at either end of the enclosure 24 to facilitate connection to the lithographic exposure radiation source and to a photodetector P. The inlet port 26 has an adjustable valve V for adjusting the flow rate of the gas purge. An additional valve may be included for connecting the enclosure 24 to an evacuation port either through the inlet or outlet ports 26, 28 or through an additional port 9not shown). The outlet port is connected to a moisture content monitoring system 30 and an O₂ monitoring system 32.

The preferred system for application processing would include a window 18 as described above with respect to FIG. 4a and the photodetector would be replaced by an application process such as an imaging system and workpiece or only a workpiece, wherein the imaging system and/or workpiece would typically be in a housing sealably connected to the enclosure 24, just as the photodetector is shown in FIG. 4b to be sealably connected to the enclosure 24.

Long term exposure tests were carried out using a photodetector P including pre-production-type SXUV -and PtSi-photodiodes. In this way, the output energy of the VUV beam could be accurately measured so that effect on that energy by changing materials, such as of the enclosure itself or of the purging gas supply, and other parameters, such as the pressure, of the interior of the enclosure could be noted. In addition to monitoring the output energy of the VUV beam, the experiments were also carried out with a separate, continuous monitoring of the O₂ and water vapor content within the purged exposure box 24 using the H₂O monitor 30 and O₂ monitor 32. Purge gases used were argon and nitrogen. The flow rate was varied between 10-300 l/h. The lithographic exposure radiation source power was varied between 0-10 W. In addition, the material composition of the enclosure 24 was varied (copper, stainless steel and PTFE hoses were used).

Some preferred equipment for carrying out the experiments on the increase or decrease of O₂ and H₂O-vapor density in the enclosure 24 under predetermined conditions are included below:

O₂ detection system (32): model DF153-100 from Delta F corp.

Moisture Analyzer (30): model 1C-C1 DewTrace from Edge Tech

Both analyzing systems 30 and 32 are identical to those used at MIT Lincoln Lab and operate well in a detection range of 0.1 ppm to 100 ppm for each of the contaminants measured.

Experimental set up: The exposure box 24 was purged with a flow rate of V=90 liters/hour, against open air with an estimated overpressure of <50 mbar. This range between zero and 50 mbar overpressure was recognized in the present invention, and verified in the experiments as being the range of pressures that provide optimal results. Three additional energy monitors and six energy detectors are illuminated in a long term run at 1 kHz. The beam fluence on the optics was F=10 mJ/cm², and on the detectors 10 μJ/cm² or 10 μJ/cm² depending on specific position of the optics and the detectors. The lithographic exposure radiation source was operated in Energy=constant mode, whereby power was checked by the multiple energy monitors (reading) and by a LM100E Coherent power meter. The lithographic exposure radiation source power was varied by varying the repetition rate of the lithographic exposure radiation source.

Some Background Information

Jenoptik LOS has summarized the absorption cross sections of the various contaminants at 157 nm (see Table 1). Other references review the absorption of these molecules in a wider range of wavelengths (see FIG. 5). The absorption coefficients of O₂, water vapor, and N₂ are, respectively, 140 cm⁻¹, 64 cm⁻, <0.0002 cm⁻¹. The general contamination levels which are in discussion as being desired for the various stages of a lithography system including a VUV or ArF lithographic exposure radiation source in accord with the present invention cover a range between less than 1 ppm and more than 100 ppm (referring to most clean optics regions and open end wafer stages). A purity of the N₂ purge gas of a grade 7.0 or even 9.0 is preferred, although grade 5.0 purity N₂ gas may be sufficient depending on other system conditions.

Effect of N2 Purge Gas Delivery

A first identified result of this investigation pursuant to the recognition in the present invention that materials making up the enclosure may effect the contamination level in the enclosure reveals that PTFE tubing is not desirable for use as a material for the enclosure 4. A brief summary follows:

The contamination level of O₂ for:

(a) stainless steel tubing was 0.3 ppm (with the VUV lithographic exposure radiation source beam turned off);

(b) purge through copper tube, output of exposure box was 0.5 ppm (with the VUV lithographic exposure radiation source beam turned off);

(c) purge through copper tube, output of exposure box, was 0.8 ppm (with the VUV lithographic exposure radiation source beam turned on)

(d) purge through PTFE-tubes, output of exposure box, 3.5 ppm (with the VUV lithographic exposure radiation source beam turned on)

(e) additional 4 m MFA—gas delivery hose inserted (all other conditions the same)˜8 ppm (with the VUV lithographic exposure radiation source beam turned on).

These findings reveal that the preferred housing 24 is made of stainless steel or copper, and that PTFE and MFA hosing is not desired. The contamination level, and resulting attenuation of the VUV beam, is substantially higher when PTFE hoses are used as opposed to when a stainless steel or copper housing is used. Another material such as glass could be used for achieving low contamination levels comparable with those achieved using copper or stainless, but glass is not preferred for other considerations such as handling practicalities in these systems.

These findings quantitatively confirm another recognition of the present invention that when the VUV lithographic exposure radiation source beam is turned on, the contamination level is higher than when the beam is off. It is recognized in the invention, and the experiments showed, that H₂O vapor/moisture contamination levels were relatively uneffected by the different setups of tubing or housing materials, or by the lithographic exposure radiation source operation conditions, i.e., whether the VUV beam was turned on or off.

Repeatable experiments revealed some interesting observations regarding the following typical behavior with respect to the time constant rate of change of the contamination level after opening the exposure box:

0₂ H₂0

Exposure box closed, 1 pump-flush w/ N2 cycle, start 1.2 ppm 2.0 ppm

Lithographic exposure radiation source on, increase in O₂ contamination, after 30 min.:

2.0 ppm 1.9 ppm

Lithographic exposure radiation sources keeps running continuously, e.g., after 2.5 h:

1.3 ppm 1.6 ppm

Lithographic exposure radiation source continuously on, after longer time, e.g., 15 h

0.5 ppm 0.8 ppm

These levels thereafter, e.g., after 2 days: ˜0.4-0.5 ppm ˜0.8-0.9 ppm

If lithographic exposure radiation source is switched off, but exposure chamber is continued to be purged w/o interrupt, the ₂ contamination level drops fast down to, about 0.25-0.30 ppm

If after a pause the lithographic exposure radiation source is switched on again, the 0₂ concentration rises again to about 0.45-0.55 ppm.

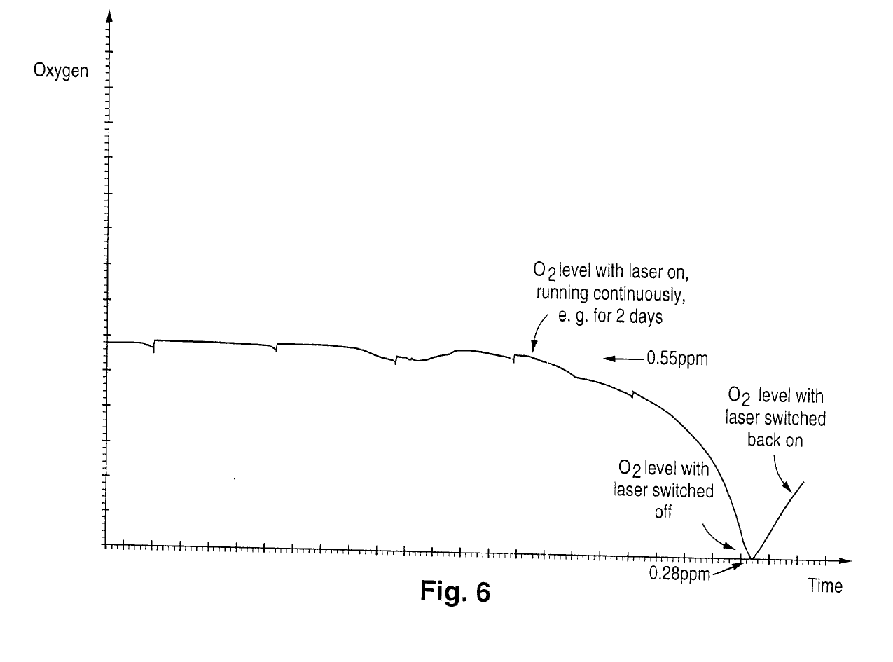

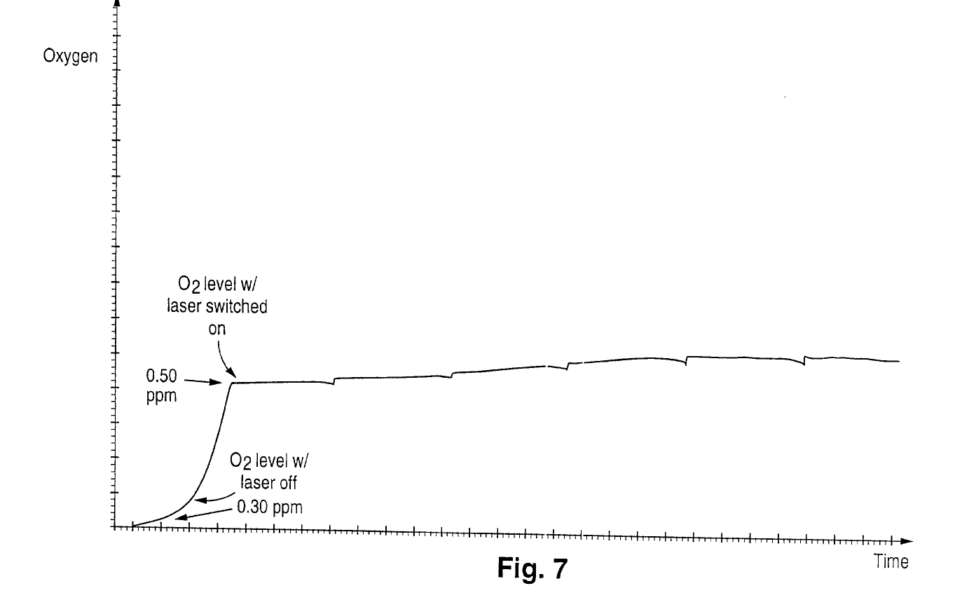

This behavior is illustrated by the experimental results shown at FIGS. 6 and 7.

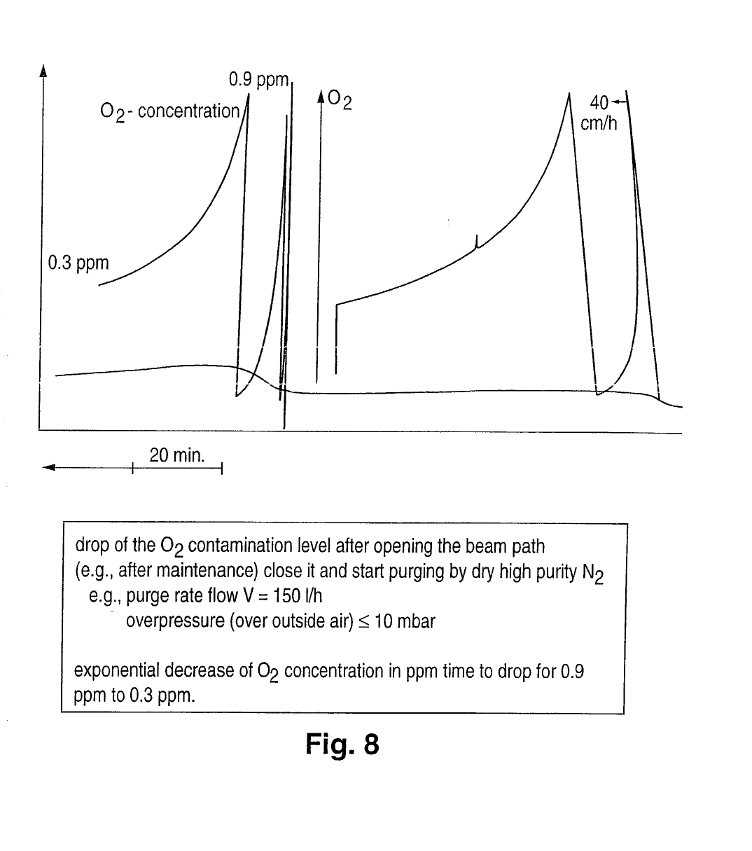

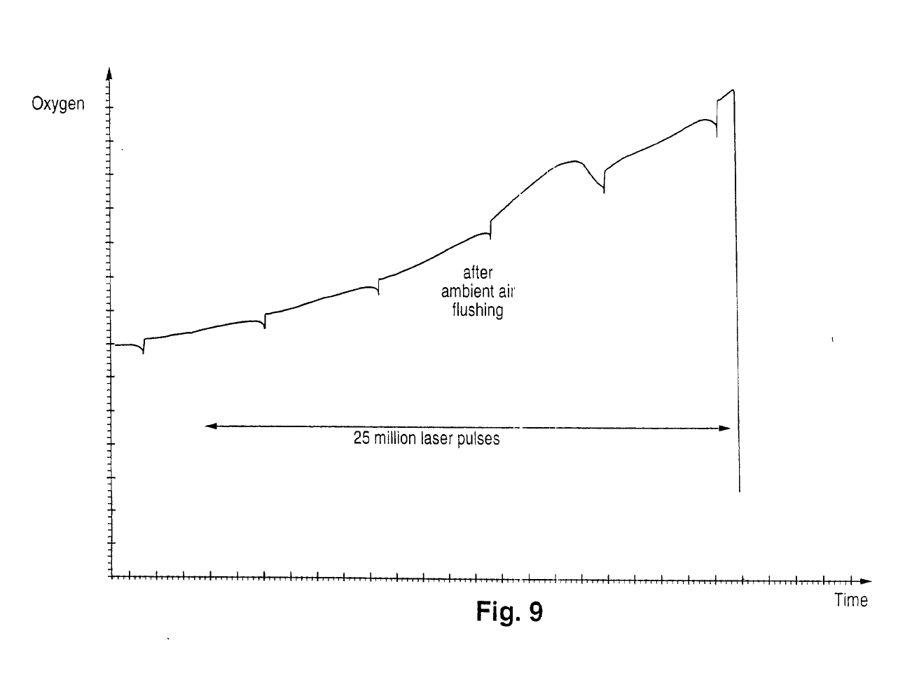

Another interesting observation shows the decrease of the 0₂ level after flushing the exposure box with normal air and with pure 0₂, both up to normal pressure. The decrease of 0₂ contamination occurs with two different time constants from the 1 ppm level (1 ppm=full scale of the plotter and v=3 cm/h), as illustrated by the experimental results shown at FIGS. 8 and 9. Thus, after about 4.3 Million lithographic exposure radiation source pulses or shots, as shown in FIG. 8, a constant low 0₂ level in the case of pure 0₂ flushing is again achieved. After more than 25 Million pulses, as shown in FIG. 9, the low constant level is achieved when the box is instead flushed with ambient air.

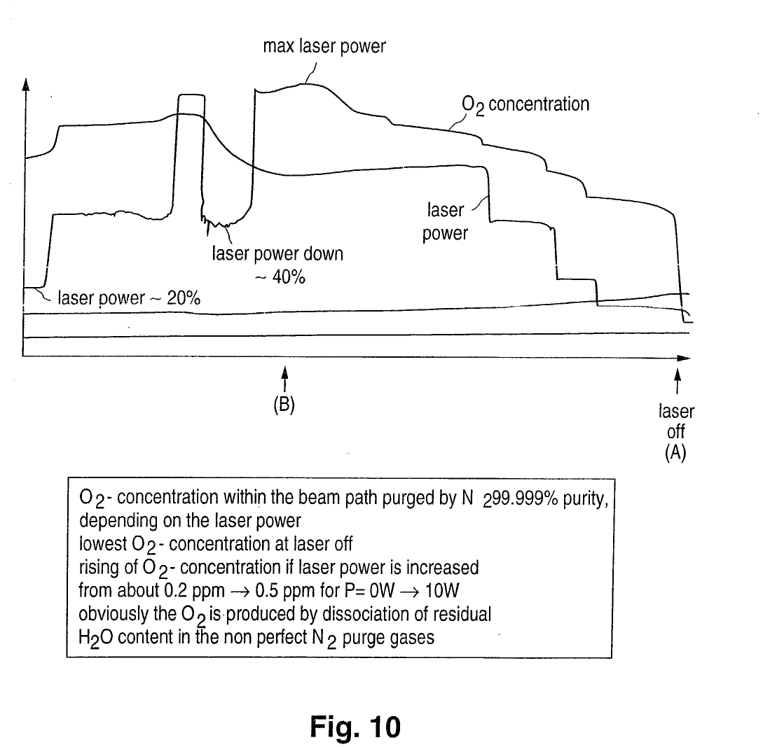

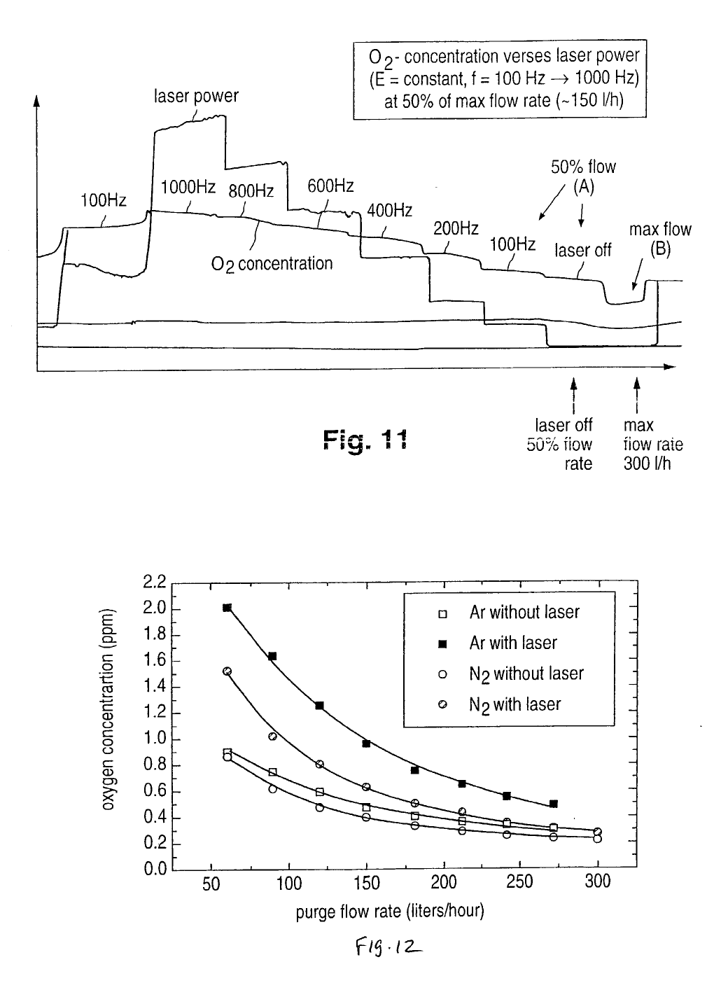

FIGS. 10 and 11 each show overlayed plots of O₂ concentration within the purged beam path enclosure of the preferred embodiment and lithographic exposure radiation source power as a function of time. Each of FIGS. 10 and 11 illustrate how the O₂ concentration depends on the lithographic exposure radiation source power.

The beam path enclosure of FIG. 10 was purged with 99.999% purity N₂ gas, or “5 grade” N₂ gas. The lowest O₂ concentration was observed when the lithographic exposure radiation source was turned off (A). The O₂ concentration is shown to increase with increasing lithographic exposure radiation source power from about 0.2 ppm when the lithographic exposure radiation source is turned off to about 0.5 ppm when the lithographic exposure radiation source is at full power (around 10 W).

It is recognized in the present invention that O₂ is likely produced by dissociation of residual H₂O content in the non-perfect N₂ gas purge. Thus, high purity inert purge gas is preferred. The inert gas may be a noble gas or nitrogen or another gas that does not absorb VUV radiation, and is preferably N₂, He, Ne, Kr or Ar. The purity of the inert purge gas is preferably greater than 99.5% purity. Even more preferred is a higher grade purity N₂ gas, such as at least 99.9% purity or more. The 5 grade purity nitrogen gas, i.e., 99.999% purity, used in the experiments is an example. In addition, “7 grade” or 99.99999% pure N₂ gas may be advantageously used for reducing the O₂ concentration in the purged beam path enclosure of the preferred embodiment. Still greater purity inert purge gas such as 9 grade, or 99.9999999% purity gas would result in a lower O₂ concentration in the enclosure. These purities may also be used for another inert gas such as He, Ne, Kr or Ar.

The beam path enclosure of FIG. 11 was purged with N₂ gas at flow rates of around 150 liters/hour and 300 liters/hour, demonstrating that the O₂ concentration reduces with increased N₂ flow rate. The lithographic exposure radiation source was operated in energy constant mode and the lithographic exposure radiation source power was varied by varying the repetition rate from 100 Hz to 1000 Hz. The O₂ concentration was observed to decrease with decreasing lithographic exposure radiation source power.

FIGS. 12-14 confirm the recognition in the present invention that the gas flow rate, inert gas used and lithographic exposure radiation source power each affect the concentration of oxygen in the enclosure 24. FIG. 12 shows plots of O₂ concentration versus purge flow rate for argon purge gas with the lithographic exposure radiation source on and off, and for nitrogen purge gas with the lithographic exposure radiation source on and off. The experiments showed that the oxygen concentration reduces sharply with flow rate up to around 150 l/h, and decreases more gradually from 150 l/h to 300 l/h for both gases with the lithographic exposure radiation source on or off. The nitrogen purge gas yielded lower oxygen concentrations than the argon purge gas under the same lithographic exposure radiation source operation conditions. The oxygen concentration was greatly reduced when the lithographic exposure radiation source was turned off compared with when the lithographic exposure radiation source was turned on.

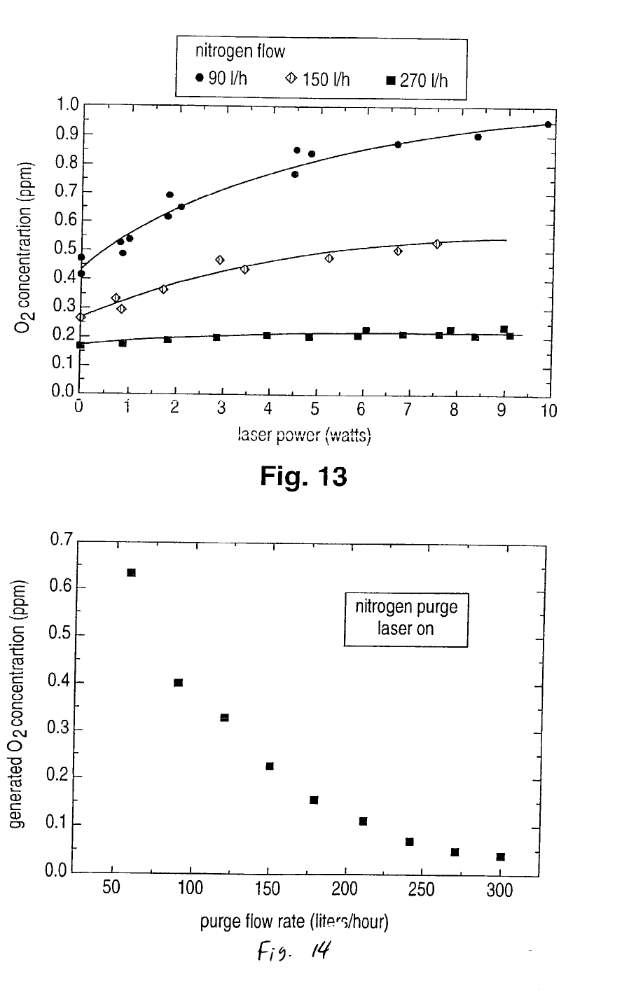

FIG. 13 shows the dependence of the oxygen concentration in the enclosure 24 on the lithographic exposure radiation source power at varying nitrogen purge gas flow rates of 90 l/h, 150 l/h and 270 l/h. Higher oxygen concentrations were observed at lower flow rates. Although the oxygen concentration increased with lithographic exposure radiation source power at each flow rate, the oxygen concentration increased more rapidly with lithographic exposure radiation source power at lower flow rate. For example, at 270 l/h, the oxygen concentration is barely observed to increase from 0-10 W lithographic exposure radiation source power, remaining around 0.2 ppm, whereas at 90 l/h, the oxygen concentration increased from around 0.4 ppm to around 1.0 ppm from 0-10 W lithographic exposure radiation source power.

FIG. 14 shows the generated O₂ concentration versus nitrogen purge flow rate with the lithographic exposure radiation source turned on and operating at around 5.4 W. The oxygen concentration is observed to decrease substantially asymptotically from around 0.6 ppm at 50 l/h to around 0.05 ppm at 300 l/h, wherein the plot is of the estimated oxygen concentration generated due to the presence of the VUV lithographic exposure radiation source beam in the enclosure, instead of the total O₂ concentration.

In brief, a contamination level of less than 1 ppm can be achieved for both 0₂ and H₂0 in a purging enclosure 4 such as that described above wherein the purging gas is 5.0 grade N₂. There is no tendency observed of approaching the Zero-light-level, or lithographic exposure radiation source off level, even when the lithographic exposure radiation source is running for several days. The VUV-radiation itself appears to increase the O₂ content in the outlet of the enclosure. It may be speculated that the reason for this is one or more of the following:

(a) a cracking of residual H₂0 content in the N₂ purge gas; and

(b) outgassing from mirrors and/or beam splitter surfaces or from the walls of the enclosure 4 (but this should be run in an asymptotic decrease of the O₂ content, too).

As described above and at FIGS. 6 and 7, it is observed that there is an increase of the O₂ contamination level when the lithographic exposure radiation source radiation is on versus when the lithographic exposure radiation source is turned off.

It is therefore advantageous to have the window 18 shown at FIG. 4 and described above to separate the enclosure 4 of the molecular fluorine lithographic exposure radiation source from the purge volume of external processing equipment and/or the workpiece that the VUV beam is directed to. Otherwise, contamination which arises due to the VUV radiation in the enclosure 4 may contaminate the purge volume of the external equipment or workpiece at an undesirable or intolerable level.

In addition, the experiments showed that higher O₂ contamination levels occur when PTFE-hoses are used in the enclosure 4 of the lithographic exposure radiation source purge gas line versus using stainless steel and/or copper for the material of the enclosure. Thus, advantageously, the enclosure of the present invention uses stainless steel and/or copper for the material of the enclosure.

The preferred embodiment can be applied as well to an enclosure for a beam line for other radiation below 200 nm, such as is affected by absorption in O₂ and H₂O. Examples include the 193 nm output emission of the ArF excimer lithographic exposure radiation source, or a frequency multiplied output of a solid state lithographic exposure radiation source or dye lithographic exposure radiation source. That is, a fluctuation in 0₂ will effect the amount of absorption occurring in a 193 nm beam line, or another sub-200 nm beam line, and so the present invention may be advantageously applied to the ArF lithographic exposure radiation source, or another lithographic exposure radiation source emitting under 200 nm, as well as to the molecular fluorine lithographic exposure radiation source.

The above description is not meant to set forth or limit in any way the scope of the present invention, but only to provide examples of preferred and alternative embodiments. Instead, the scope of the present invention is that set forth in the claims that follow, and structural and functional equivalents thereof.

For example, what is described at any of U.S. Pat. Nos. 6,005,880 and 6,002,697, and U.S. patent applications Ser. No. 09/317,695, 09/130,277, 09/172,805, 09/379,034, 09/244,554, 09/317,527, 09/327,526, 09/447,882, 60/162,845, 09/453,670, 60/122,145, 60/140,531, 60/166,952, 60/173,993, 60/166,277 and 60/140,530, each of which is assigned to the same assignee and is hereby incorporated by reference, may be practiced in combination with what is described above and below.

The preferred embodiments described below provide means of on-line monitoring of the output power of a lithographic exposure radiation source, and particularly a vacuum UV laser, specifically a molecular fluorine laser, operating in a wavelength range below 200 nm . Preferred and alternative embodiments described below further provide means of minimizing variations of sensitivity of energy monitor due to absorption, as well as suppressing a visible red portion of the output of the molecular fluorine laser. The former is generally achieved by providing a hermetic enclosure which is preferably purged with an inert gas. The latter is preferably provided by one of three techniques including the use of a diffraction grating, a dichroic thin-film dielectric mirror arrangement, or a holographic beam sampler.

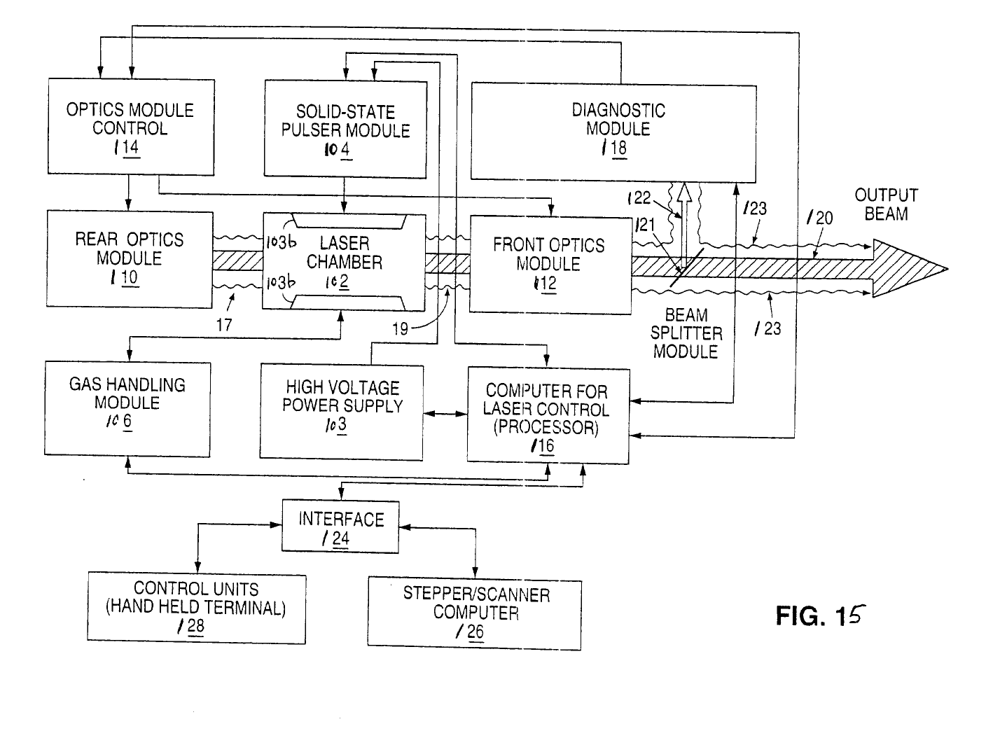

Referring to FIG. 15, a VUV laser system, preferably a molecular fluorine laser for deep ultraviolet (DUV) or vacuum ultraviolet (VUV) lithography, is schematically shown. Alternative configurations for laser systems for use in such other industrial applications as TFT annealing and/or micromachining, e.g., are understood by one skilled in the art as being modified from the system shown in FIG. 15 to meet the requirements of that application. For this purpose, alternative VUV laser system and component configurations are described at U.S. patent applications Ser. Nos. 09/317,695, 09/317,526, 09/317,527, 09/343,333, 60/122,145, 60/140,531, 60/162,735, 60/166,952, 60/171,172, 60/141,678, 60/173,993, 60/166,967, 60/172,674, and 60/181,156, and U.S. patent application of Kleinschmidt, serial number not yet assigned, filed May 18, 2000, for “Reduction of Laser Speckle in Photolithography by Controlled Disruption of Spatial Coherence of Laser Beam,” and U.S. Pat. No. 6,005,880, each of which is assigned to the same assignee as the present application and is hereby incorporated by reference.

The system shown in FIG. 15 generally includes a laser chamber 102 having a pair of main discharge electrodes 103b connected with a solid-state pulser module 104, and a gas handling module 106. The solid-state pulser module 104 is powered by a high voltage power supply 108. The laser chamber 102 is surrounded by optics module 110 and optics module 112, forming a resonator. The optics modules 110 and 112 are controlled by an optics control module 114.

A computer 116 for laser control receives various inputs and controls various operating parameters of the system. A diagnostic module 118 receives and measures various parameters of a split off portion of the main beam 120 via optics for deflecting a small portion of the beam toward the module 118, such as preferably a beam splitter module 121, as shown. The beam 120 is preferably the laser output to an imaging system (not shown) and ultimately to a workpiece (also not shown). The laser control computer 116 communicates through an interface 24 with a stepper/scanner computer 126 and other control units 128.

The laser chamber 102 contains a laser gas mixture and includes a pair of main discharge electrodes and one or more preionization electrodes (not shown). Preferred main electrodes 103b are described at U.S. patent applications Ser. Nos. 09/453,670, 60/184,705 and 60/128,227, each of which is assigned to the same assignee as the present application and is hereby incorporated by reference. Other electrode configurations are set forth at U.S. Pat. Nos. 5,729,565 and 4,860,300, each of which is assigned to the same assignee, and alternative embodiments are set forth at U.S. Pat. Nos. 4,691,322, 5,535,233 and 5,557,629, all of which are hereby incorporated by reference. The laser chamber 102 also includes a preionization arrangement (not shown). Preferred preionization units are set forth at U.S. patent applications Ser. Nos. 60,162,845, 60/160,182, 60/127,237, 09/535,276 and 09/247,887, each of which is assigned to the same assignee as the present application, and alternative embodiments are set forth at U.S. Pat. Nos. 5,337,330, 5,818,865 and 5,991,324, all of the above preionization units being hereby incorporated by reference.

The solid-state pulser module 14 and high voltage power supply 103 supply electrical energy in compressed electrical pulses to the preionization and main electrodes within the laser chamber 102 to energize the gas mixture. The preferred pulser module and high voltage power supply are described at U.S. patent applications Ser. Nos. 60/149,392, 60/198,058, and 09/390,146, and U.S. patent application of Osmanow, et al., serial number not yet assigned, filed May 15, 2000, for “Electrical Excitation Circuit for Pulsed Laser”, and U.S. Pat. Nos. 6,005,880 and 6,020,723, each of which is assigned to the same assignee as the present application and which is hereby incorporated by reference into the present application. Other alternative pulser modules are described at U.S. Pat. Nos. 5,982,800, 5,982,795, 5,940,421, 5,914,974, 5,949,806, 5,936,988, 6,028,872 and 5,729,562, each of which is hereby incorporated by reference. A conventional pulser module may generate electrical pulses in excess of 3 Joules of electrical power (see the '988 patent, mentioned above).

The laser resonator which surrounds the laser chamber 102 containing the laser gas mixture includes optics module 110 including line-narrowing optics for a line narrowed excimer or molecular fluorine laser, which may be replaced by a high reflectivity mirror or the like if line-narrowing is not desired. Exemplary line-narrowing optics of the optics module 110 include a beam expander, an optional etalon and a diffraction grating, which produces a relatively high degree of dispersion, for a narrow band laser such as is used with a refractive or catadioptric optical lithography imaging system. For a semi-narrow band laser such as is used with an all-reflective imaging system, the grating is replaced with a highly reflective mirror, and a lower degree of dispersion may be produced by a dispersive prism.

The beam expander of the line-narrowing optics of the optics module 110 typically includes one or more prisms. The beam expander may include other beam expanding optics such as a lens assembly or a converging/diverging lens pair. The grating or highly reflective mirror is preferably rotatable so that the wavelengths reflected into the acceptance angle of the resonator can be selected or tuned. The grating is typically used, particularly in KrF and ArF lasers, both for achieving narrow bandwidths and also often for retroreflecting the beam back toward the laser tube. One or more dispersive prisms may also be used, and more than one etalon may be used.

Depending on the type and extent of line-narrowing and/or selection and tuning that is desired, and the particular laser that the line-narrowing optics of the optics module 110 is to be installed into, there are many alternative optical configurations that may be used. For this purpose, those shown in U.S. Pat. Nos. 4,399,540, 4,905,243, 5,226,050, 5,559,816, 5,659,419, 5,663,973, 5,761,236, and 5,946,337, and U.S. patent applications Ser. Nos. 09/317,695, 09/130,277, 09/244,554, 09/317,527, 09/073,070, 60/124,241, 60/140,532, 60/147,219 and 60/140,531, 60/147,219, 60/170,342, 60/172,749, 60/178,620, 60/173,993, 60/166,277, 60/166,967, 60/167,835, 60/170,919, 60/186,096, each of which is assigned to the same assignee as the present application, and U.S. Pat. Nos. 5,095,492, 5,684,822, 5,835,520, 5,852,627, 5,856,991, 5,898,725, 5,901,163, 5,917,849, 5,970,082, 5,404,366, 4,975,919, 5,142,543, 5,596,596, 5,802,094, 4,856,018, 5,970,082, 5,978,409, 5,999,318, 5,150,370 and 4,829,536, are each hereby incorporated by reference into the present application.

Optics module 112 preferably includes means for outcoupling the beam 120, such as a partially reflective resonator reflector. The beam 120 may be otherwise outcoupled such as by an intraresonator beam splitter or partially reflecting surface of another optical element, and the optics module 112 would in this case include a highly reflective mirror. The optics control module 14 controls the optics modules 110 and 112 such as by receiving and interpretting signals from the processor 116, and initiating realignment or reconfiguration procedures (see the '241, '695, 277, 554, and 527 applications mentioned above).

The laser chamber 102 is sealed by windows transparent to the wavelengths of the emitted laser radiation 114. The windows may be Brewster windows or may be aligned at another angle to the optical path of the resonating beam. The beam path between the laser chamber and each of the optics modules 110 and 112 is sealed by enclosures 117 and 119, and the interiors of the enclosures is substantially free of water vapor, oxygen, hydrocarbons, fluorocarbons and the like which otherwise strongly absorb VUV laser radiation.

After a portion of the output beam 120 passes the outcoupler of the optics module 112, that output portion impinges upon beam splitter module 121 which includes optics for deflecting a portion of the beam to the diagnostic module 118, or otherwise allowing a small portion of the outcoupled beam to reach the diagnostic module 118, while a main beam portion 120 is allowed to continue as the output beam 120 of the laser system. Preferred optics include a beamsplitter or otherwise partially reflecting surface optic. The optics may also include a mirror or beam splitter as a second reflecting optic. More than one beam splitter and/or HR mirror(s), and/or dichroic mirror(s) may be used to direct portions of the beam to components of the diagnostic module 18. A holographic beam sampler, transmission grating, partially transmissive reflection diffraction grating, grism, prism or other refractive, dispersive and/or transmissive optic or optics may also be used to separate a small beam portion 122 from the main beam 120 for detection at the diagnostic module 118, while allowing most of the main beam 120 to reach an application process directly or via an imaging system or otherwise. The output beam 120 may be transmitted at the beam splitter module while a reflected beam portion 122 is directed at the diagnostic module 118, or the main beam 120 may be reflected, while a small portion 122 is transmitted to the diagnostic module 118. The portion of the outcoupled beam which continues past the beam splitter module 121 is the output beam 120 of the laser, which propagates toward an industrial or experimental application such as an imaging system and workpiece for photolithographic applications.

An enclosure 123 seals the beam path of the beams 122 and 120 such as to keep the beam paths free of photoabsorbing species. The enclosure 123 and beam splitting module 121 will be described in more detail below with respect to FIGS. 16-21b. For example, the beam splitting module 121 preferably also includes optics for filtering visible red light from the beam 122 so that substantially only VUV light is received at a detector of the diagnostic module 118. Also, an inert gas purge is preferably flowing through the enclosure 123.

The diagnostic module 118 preferably includes at least one energy detector. This detector measures the total energy of the beam portion that corresponds directly to the energy of the output beam 120. An optical configuration such as an optical attenuator, e.g., a plate or a coating, or other optics may be formed on or near the detector or beam splitter module 121 to control the intensity, spectral distribution and/or other parameters of the radiation impinging upon the detector (see U.S. patent applications Ser. Nos. 09/172,805, 60/172,749, 60/166,952 and 60/178,620, each of which is assigned to the same assignee as the present application and is hereby incorporated by reference).

One other component of the diagnostic module 118 is preferably a wavelength and/or bandwidth detection component such as a monitor etalon or grating spectrometer (see U.S. patent applications Ser. Nos. 09/416,344, 60/186,003, 60/158,808, and 60/186,096, and Lokai, et al., serial number not yet assigned, “Absolute Wavelength Calibration of Lithography Laser Using Multiple Element or Tandem See Through Hollow Cathode Lamp”, filed May 10, 2000, each of which is assigned to the same assignee as the present application, and U.S. Pat. Nos. 4,905,243, 5,978,391, 5,450,207, 4,926,428, 5,748,346, 5,025,445, and 5,978,394, all of the above wavelength and/or bandwidth detection and monitoring components being hereby incorporated by reference.

Other components of the diagnostic module may include a pulse shape detector or ASE detector, such as are described at U.S. patent applications Ser. Nos. 09/484,818 and 09/418,052, respectively, each of which is assigned to the same assignee as the present application and is hereby incorporated by reference, such as for gas control and/or output beam energy stabilization. There may be a beamalignment monitor, e.g., such as is described at U.S. Pat. No. 6,014,206 which is hereby incorporated by reference.

The processor or control computer 116 receives and processes values of some of the pulse shape, energy, amplified spontaneous emission (ASE), energy stability, energy overshoot for burst mode operation, wavelength, spectral purity and/or bandwidth, among other input or output parameters of the laser system and output beam. The processor 116 also controls the line narrowing module to tune the wavelength and/or bandwidth or spectral purity, and controls the power supply and pulser module 104 and 103 to control preferably the moving average pulse power or energy, such that the energy dose at points on the workpiece is stabilized around a desired value. In addition, the computer 116 controls the gas handling module 106 which includes gas supply valves connected to various gas sources.

The laser gas mixture is initially filled into the laser chamber 102 during new fills. The gas composition for a very stable excimer laser in accord with the preferred embodiment uses helium or neon or a mixture of helium and neon as buffer gas, depending on the laser. Preferred gas composition are described at U.S. Pat. Nos. 4,393,405 and 4,977,573 and U.S. patent applications Ser. Nos. 09/317,526, 09/513,025, 60/124,785, 09/418,052, 60/159,525 and 60/160,126, each of which is assigned to the same assignee and is hereby incorporated by reference into the present application. The concentration of the fluorine in the gas mixture may range from 0.003% to 1.00%, and is preferably around 0.1%. An additional gas additive, such as a rare gas, may be added for increased energy stability and/or as an attenuator as described in the '025 application, mentioned above. Specifically, for the F2-laser, an addition of Xenon and/or Argon may be used. The concentration of xenon or argon in the mixture may range from 0.0001% to 0.1%. For an ArF-laser, an addition of xenon or krypton may be used also having a concentration between 0.0001% to 0.1%.

Halogen and rare gas injections, total pressure adjustments and gas replacement procedures are performed using the gas handling module 106 preferably including a vacuum pump, a valve network and one or more gas compartments. The gas handling module 106 receives gas via gas lines connected to gas containers, tanks, canisters and/or bottles. Preferred gas handling and/or replenishment procedures of the preferred embodiment, other than as specifically described herein, are described at U.S. Pat. Nos. 4,977,573 and 5,396,514 and U.S. patent applications Ser. No. 60/124,785, 09/418,052, 09/379,034, 60/171,717, and 60/159,525, each of which is assigned to the same assignee as the present application, and U.S. Pat. Nos. 5,978,406, 6,014,398 and 6,028,880, all of which are hereby incorporated by reference. A Xe gas supply may be included either internal or external to the laser system according to the 3 025 application, mentioned above.

Referring now to FIG. 16, a first preferred embodiment of a beam delivery system includes the enclosure 123, mentioned briefly above, which seals the beam paths of the-beams 120 and 122 everywhere after the beam is outcoupled from the laser system until the beam 120 reaches the application process 130. The enclosure 123 is maintained substantially free of photoabsorbing species such as water vapor, oxygen, hydrocarbons and fluorocarbons preferably by a method as set forth at U.S. patent application Ser. No. 09/343,333, incorporated by reference above.

Briefly, the preferred method, as described in more detail in the '333 application, is a method wherein the enclosure 123 is first pumped down to a rough vacuum, e.g., using a mechanical roughing pump, such as a rotary vane pump. Next, an inert gas is purged into the enclosure 123. The vacuum/purging steps are preferably performed some optimal number of times, such as from one to ten times, balancing the removal of photoabsorbing impurities in the enclosure 123 with the time it takes to perform those steps. Then, an inert gas is flowed at a slight overpressure (e.g., <50 mbar) using gas inlets 132a and 132b and gas outlet 134. The lithographic exposure radiation source is operated with the inert gas flowing at the slight overpressure. The above method is preferred as being time and cost efficient. Two alternative methods which may, however, be used for keeping the beam path substantially free of photoabsorbing species are pumping the enclosure 123 to high vacuum, and flowing an inert gas at high flow rate through the enclosure 123.

The application process 130 may include a separate housing for the workpiece and/or additional optical equipment such as an imaging system, or may be the workpiece itself. Two reflectors 136a and 136b, preferably both being beam splitters or one reflector 136a being a beam splitter and the other reflector 136b being a mirror, are shown for splitting off beam 122 and allowing the substantial portion of the beam 120 to pass through unhindered towards the application process 130. The beam 122 is directed ultimately to the detector 138, preferably via a collecting lens, grids and a diffuser (collectively 140), and a signal 142 corresponding to the energy measured is sent to a processor (not shown) or other data acquisition equipment using a vacuum feedthrough 144. A visible red light portion of the beam 122 for the molecular fluorine laser is preferably first filtered such that substantially only the sub-200 portion of the beam 122 reaches the detector 138, as described in more detail below.

The reflectors 136a and 136b preferably each comprise uncoated plates made of excimer grade CaF₂, MgF₂ quartz, fused silica, doped fused silica, LiF, BaF₂, or other material that is mostly transparent to VUV radiation in the embodiment for the molecular fluorine laser. In this case, the reflectivity of each reflector 36a and 36b is preferably approximately 3-15%, e.g., 8%. Additional dielectric coatings can be deposited onto preferred reflectors 136a and 136b in order to reduce or increase reflectivity. However, uncoated surfaces allow the preferred reflectors 136a and 136b to have longer lifetimes than those with coated surfaces.

The incidence angles of the beam onto the preferred reflectors 136a and 136b are preferably relatively small, in order to reduce the dependence of the reflectivity on the polarization of the incident laser beam, as explained below. The reflectivity of the uncoated surface for p- and s-polarized beams is described by Fresnel's formulas:

Rₛ=sin² (N−N′)/Sin² (N+N′),

Rₚ=tan² (N−N′)/tan² (N+N′),

where incident and refracted angles N and N′ are approximately related through the formula:

sin(N)=n≅sin (N′),

where n is the refractive index of the material.

Thus, for the angles that approach Brewster's angle N_{B}=arc tan(n), the reflectivity of the p-component decreases to zero, while s-components experience an increase in reflectivity. For example, for materials such as CaF₂ or MgF₂ with refractive indices of approximately 1.5, Brewster's angle N_{B} is approximately 56°. At 45° incidence, the ratio of reflectivities for s- and p-polarized beams is still as high as 10.5. One should preferably avoid such contrast since in the case of p-polarized laser output, small changes of polarization state can cause large errors in energy readings. Therefore, the incidence angles are preferably limited to less than 22.5°.

The reflectors 136a and 136b direct the beam 122 at an appropriate angle to the diffraction grating 146. The grating 146 shown is a reflection grating 146. An alternative configuration may include a transmission grating. A grism may also alternatively be used preferably made of CaF₂ or another of the VUV transparent materials set forth above for the molecular fluorine or ArF laser.

The grating 146 provides separation of the VUV beam from the red portion of the beam 122 for the F₂ laser. The incidence and reflection angles 2ᵢ and 2ᵣ into/from the diffraction grating 46 are related through the formula:

sin(2₁)−sin(2ᵣ)=m λ/d

where λ is the wavelength, m is diffraction order (m=0, +/−1, +/−2 . . . ) and d is the periodic spacing of the grooves of the grating. For example, a typical grating with the groove density of 1200 grooves/mm and an incidence angle of 11°, zeroth- and first-order reflected beams at 157 nm will be at −11° and zero°, respectively. At the same time, the nearest angles of reflection for the red light of the wavelength of approximately 700 nm will be around −11 and 40.5° degrees for zeroth- and -first orders, respectively. Thereafter, one can separate the VUV and red portions of the beam 122 by using an aperture in front of the detector as shown in FIGS. 16, 18, 19 or 20.

Collecting lens and diffuser, of the assembly 140 which also includes grids, described below, should be preferably made of one of the materials mentioned above as a choice for preferred beam-splitters 136a and 136b. The diffuser serves to attenuate the beam and also to decrease dependence of the overall sensitivity on the beamalignment. The attenuator grids are preferably fine-pitch stainless steel meshes. These serve as additional diffusers and attenuators, and additionally provide shielding of the detector against electromagnetic interference. Additional beam shaping optics, such as an aperture 147, may be includes, e.g., as set forth at U.S. patent application No. 60/172,749, which is assigned to the same assignee and is hereby incorporated by reference.

Preferably, optical components 140 and detector 138 are encased into the enclosure 123, as shown, or in a separately hermetically sealed housing with inert gas purging, having an entrance window for the beam 122. It has been observed that when such enclosure is evacuated, there tends to occur a build-up of hydrocarbon film on the optical elements exposed to the beam. This is likely caused by polymerization of organic molecules present in low-grade vacuum. Instead of providing high-vacuum enclosure, it is preferred to arrange purging, as described above (see the '333 application) with clean inert gas (such as nitrogen, helium, argon, neon and others) at a flow rate preferably around 5 liters/min or less.

Experimentally, it has been observed that purging improves stability of laser output by at least an order of magnitude, as shown in FIG. 17. FIG. 17 shows the output power of a laser in accord with the preferred embodiment of FIGS. 15 and 16. Plot 1 shows the output power when inert gas purging is used, and plot 2 shows the output power when an evacuated housing is used. Plot 1 shows the output power stabilized around 2.2 W over about 2.5 hours, while plot 2 shows the output power decreasing from around 2.8 W to around 2.5 W over the same period. Thus the energy stability observed with inert gas purging is far better than with an evacuated housing.

The gas flow path is also preferably arranged in such a way as to minimize or avoid any “dead”, un-purged spaces in the enclosure 123 of FIG. 16. For example, an additional gas inlet 132b is preferably provided as shown in FIG. 16 to the chamber encasing the detector and separated from the main beam path by grid attenuators. The collecting lens and diffuser are preferably mounted so that there are vent holes around them. Among mentioned above inert gases, it is preferred to use ultra-high purity argon, for the reason of its relatively low cost, as compared to helium and neon. Nitrogen of ultra-high purity grade typically contains higher levels of impurities as compared to UHP-helium and neon and, therefore, is less suitable for purging.

The detector 138 may be one of, but is not limited to, a silicon photodiode, pyroelectric, thermopile, electron phototube, photomultiplier, CCD-detector, or diamond detector as set forth in U.S. patent application No. 60/122,145, which is assigned to the same assignee as is hereby incorporated by reference. Preference is based on the lifetime, sensitivity, time resolution and cost.

The diffraction grating 146 is preferably aluminum-coated and protected with the thin layer of MgF₂, and may be otherwise as may be known to one skilled in the art of UV diffraction gratings. The grating may be one of those described at U.S. patent application No. 60/167,835, which is assigned to the same assignee, and U.S. Pat. No. 5,999,318, each of which is hereby incorporated by reference. Sides of the grating should be carefully protected from stray UV light by appropriate shields, for example made of aluminum foil. The purpose of the shields is to prevent degradation and outgassing of organic materials beneath the aluminum layer which are commonly used in the process of replication of gratings.

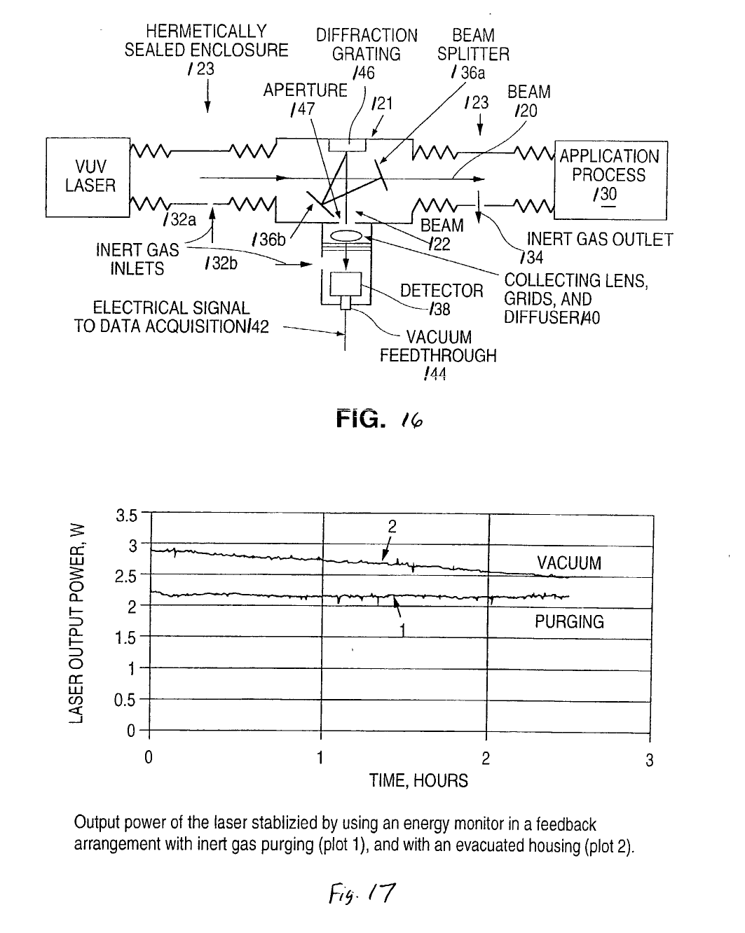

Referring to FIG. 18, the second embodiment is preferably the same or similar to the first embodiment shown and described with respect to FIG. 16, except that the second embodiment shown at FIG. 18 utilizes a holographic beam sampler 148 (for example: HBS-series from Gentec Electro-optics, Sainte-Foy, Quebec, Canada). Holographic beam sampler 148 is preferably a transmissive diffraction grating formed on a transparent substrate (see above for the choice of materials transparent in the VUV range). Advantages of the holographic beam sampler 148 include: (1) only very small portion of the beam energy is split off (typically ˜0.1% ), therefore, insertion losses are very low, e.g., as compared to ˜8% for conventional beam-splitter, and (2) wavelength separation is achieved at the same time, since the diffraction angle for the red portion of the beam is different from that of the VUV component, thus making the design simple and robust. A disadvantage of the holographic sampler 148, however, is its higher cost. The choice of preferred materials for the diffractive beam sampler is dictated by its transparency in VUV range and radiation hardness. Examples of such materials are CaF₂, MgF₂, quartz, fused silica, doped fused silica, LiF, BaF₂.

The VUV portion of the beam 120 that is diffracted at the holographic beam sampler 148 is directed to a reflector 150 such as a VUV mirror or beamsplitter. The reflector directs the VUV light toward the assembly 140 and detector 138 The reflector 150 is designed for maximum reflectance at VUV wavelengths. The reflector 150 may be at least partly transmissive at visible wavelengths to prevent or minimize red light reflection towards the detector. A copper shield may be provided around the reflector 150 to absorb this red light, e.g., so that the red light is not otherwise reflected within the enclosure towards the detector 138. An example of such an arrangement of the reflector 150 is described at U.S. patent application No. 60/166,952, which is assigned to the same assignee and is hereby incorporated by reference.

Referring to FIG. 19, the third embodiment is the same or similar to that shown and described with respect to the first embodiment of FIG. 16, except that the third embodiment of FIG. 19 utilizes dichroic dielectric mirrors 152 in order to achieve separation of the VUV beam from the red portion of the laser output. In the third embodiment shown in FIG. 19, one beam-splitter 136a and two dichroic mirrors 152 are preferably used. The dichroic mirrors 152 are preferably formed by depositing thin quarter-wave layers of dielectrics with alternating high and low refractive index, so that VUV beam is mostly reflected and red light is almost completely transmitted. Other details of dichroic mirrors 152 are understood by those skilled in the art. Typically, a contrast ratio between the reflectance of the VUV light and the red light of better than 130 can be achieved. The choice of the number of mirrors is determined by the suppression ratio desired for reducing the signal caused by the red component, e.g., below 1.0% or less. Two mirrors will typically provide at least two orders of magnitude contrast ratio.

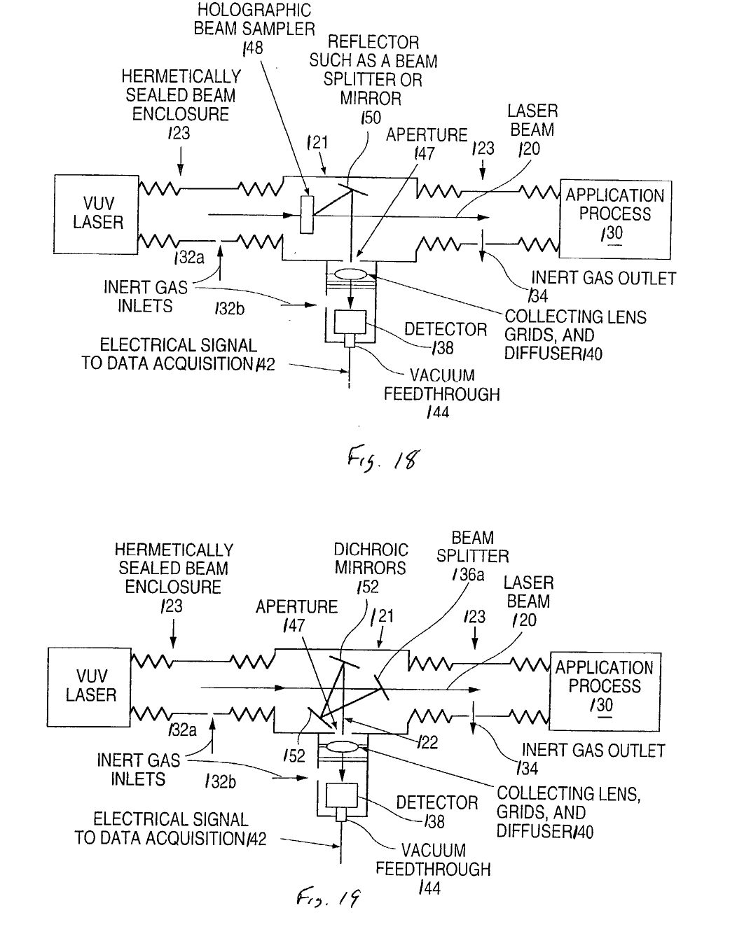

Referring to FIG. 20, the fourth embodiment is an alternative variation of the first embodiment, and as such, is the same as or similar to the first embodiment of FIG. 16, except that the fourth embodiment of FIG. 20 includes only one beam splitter 136a and a grating 146. In the arrangement of FIG. 20, the intensity of the optical signal to the detector 138 is increased compared to the first embodiment of FIG. 16. This may be desired if the sensitivity of the detector 138 is otherwise insufficient at a given output power of the laser. Alternatively, three or more beamsplitters 136a, 136b, 136c, etc., can be employed, with the advantage is some circumstances that a reduction in signal to the detector 138 may be achieved. In doing so, an advantage of reducing the intensity of the beam at the diffraction grating 146, and the assembly 140, particularly including the collecting lens and attenuator grids, is that the lifetimes of these components may be increased. At the same time, decreasing in the intensity of the beam sample can lead to a lower signal-to-noise ratio if the noise is dominated by scattered light inside the housing of the energy detector 138. Therefore, depending on the output power of the VUV laser and sensitivity of the detector 138, there is some optimum number of the beamsplitters 136a, etc. that may be selected. These considerations apply to the second and third embodiment as well as to the first embodiment.

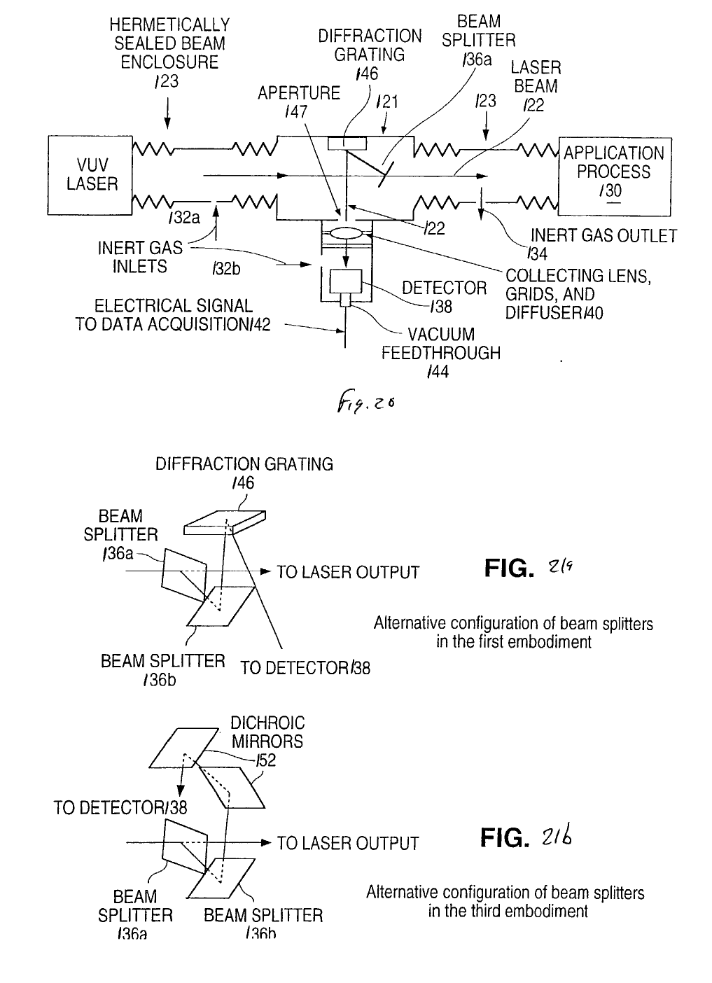

FIGS. 21a and 21b show alternative arrangements of beam-splitters that can be utilized in the first and third embodiments, respectively, preferably when the laser output is polarized. In both FIG. 21a and FIG. 21b, two reflectors 136a and 136b, preferably both beamsplitters, are used. The reflectors 136a and 136b are aligned to eliminate deviations due to polarization fluctuations and preferences based on differing reflectivities for the orthogonal polarization components.

Generally, the first beam splitter 136a and the second reflector 136b are aligned so that the polarization dependence of the reflectivity of the first beam splitter 136a is compensated by the polarization dependence of the reflectivity of the second reflector 136b. For example, the first beam splitter 136a may be aligned to reflect the p-polarization component of the incident beam at 10% of the efficiency of the s-polarization component. The second reflector 136b is then aligned to reflect the component corresponding to the s-polarization component incident at the first beam splitter 136a at 10% of the efficiency of its orthogonal counterpart corresponding to the p-polarization component incident at the first beam splitter 136a. Thus, the overall dependence on the polarization of the output beam of the reflectivity of the first beam splitter 136a-second reflector 136b combination is reduced or eliminated.

Preferably, the first reflector 136a of both FIGS. 21a and 21b is oriented in such a way that in the case that the incident laser beam is polarized, the beam is p-polarized with respect to this first beam-splitter 136a. The second reflector 136b of both FIGS. 21a and 21b is preferably oriented in a perpendicular plane to the first reflector 136a, so that the p-component of laser beam reflected from the first reflector 136a is s-polarized with respect to the second reflector 136b. Preferably, each reflector 136a and 136b reflects the beam at an incidence angle of substantially 45 degrees.

An additional advantage of this configuration of the reflectors 136a and 136b of both FIGS. 21a and 21b is that the reflectivity of the first reflector 136a for a polarized laser beam is significantly reduced, typically from about 4% to 0.1%. Therefore, more of the beam power is available for the application. At the same time, the above explained advantage of polarization selectivity of the first reflector 136a is compensated by the inverse selectivity of the second reflector 136b, since p- and s-components of the incident beam become s- and p-components, respectively, at the second reflector 136b.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

In addition, in the method claims that follow, the steps have been ordered in selected typographical sequences. However, the sequences have been selected and so ordered for typographical convenience and are not intended to imply any particular order for performing the steps, except for those claims wherein a particular ordering of steps is expressly set forth or understood by one of ordinary skill in the art as being necessary.

What is claimed is:

1. A beam delivery system for delivering a lithographic exposure radiation source beam including a wavelength less than 200 nm to an external housing leading ultimately to a workpiece, comprising:
an enclosure separating at least a portion of the beam path exiting the lithographic exposure radiation source from the outer atmosphere;
one or more ports for evacuating the enclosure and removing sub-200 nm photoabsorbing species therefrom and maintaining said beam path substantially free of sub-200 nm photoabsorbing species to enable the beam to propagate along said beam path, such that the energy of the beam can traverse said enclosure without substantial attenuation due to the presence of photoabsorbing species along said beam path

2. The system of claim 1, wherein said enclosure substantially comprises one or more materials selected from the group of materials consisting of stainless steel and copper.

3. The system of claim 1, wherein said enclosure contains no more than 0.5 ppm O₂.

4. The system of claim 1, wherein said enclosure is sealably coupled to said lithographic exposure radiation source.

5. The system of claim 1, in which the beam is provided by a laser selected from the group consisting of an ArF and a F₂ laser.

6. A beam delivery system for delivering a lithographic exposure radiation source beam including a wavelength less than 200 nm to an external housing leading ultimately to a workpiece, comprising:
an enclosure separating at least a portion of the beam path exiting the exposure radiation source from the outer atmosphere;
one or more ports for evacuating the enclosure and flowing an inert gas of greater than 99.5% purity within said enclosure and maintaining said beam path substantially free of sub-200 nm photoabsorbing species to enable the beam to propagate along said beam path, such that the energy of the beam can traverse said enclosure without substantial attenuation due to the presence of photoabsorbing species along said beam path

7. The system of claim 6, wherein the purity of said inert gas is at least 99.9%.

8. The system of claim 7, wherein said inert gas is selected from the group of gases including nitrogen, argon, neon, krypton and helium.

9. The system of claim 7, wherein said inert gas comprises nitrogen.

10. The system of claim 7, wherein said inert gas comprises argon.

11. The system of claim 6, wherein the purity of said inert gas is at least 99.999%.

12. The system of claim 6, wherein the purity of said inert gas is at least 99.99999%.

13. The system of claim 6, in which the beam is provided by a laser selected from the group consisting of an ArF and a F₂ laser.

14. The system of claim 6, wherein said inert gas is flowed at a flow rate of at least 150 liters per hour.

15. The system of claim 6, wherein said plurality of ports includes a port for evacuating, said enclosure prior to flowing said inert gas therethrough, and wherein said inert gas is flowed at a flow rate of less than substantially 0.2 liters per minute.

16. The system of claim 15, wherein said enclosure is maintained at an overpressure of less than substantially 50 mbar.

17. The system of claim 6, wherein said enclosure substantially comprises one or more materials selected from the group of materials consisting of stainless steel and copper.

18. The system of claim 6, wherein said enclosure contains no more than 0.5 ppm O₂.

19. The system of claim 6, wherein said enclosure is sealably coupled to said lithographic exposure radiation source.

20. A method of delivering a sub-200 nm lithographic exposure radiation portion from a main beam which is generated by a lithographic exposure radiation source for use at an application process to a detector for monitoring a parameter of the beam, comprising the steps of:
sealing off a beam path within an enclosure optically coupled with the detector;
preparing the interior of the enclosure for transmitting the main beam and the sub-200 nm lithographic exposure radiation portion for delivery to the detector such that said interior is substantially free of sub-200 nm photoabsorbing species, and wherein said exposure radiation portion that is delivered to the detector is directed along a beam path within said enclosure and is thereby protected from being substantially attenuated by said sub-200 nm photoabsorbing species;
separating said exposure radiation portion for delivery to the detector from the main beam; and
detecting the exposure radiation portion separated from said main beam at said separating step and delivered to the detector along said beam path and not substantially attenuated by said sub-200 nm photoabsorbing species.

21. The method of claim 20, wherein said preparing step includes evacuating said enclosure.

22. The method of claim 20, wherein said preparing step includes flowing an inert gas through said enclosure.

23. The method of claim 22, wherein said preparing step further includes evacuating said enclosure prior to said inert gas flowing step.

24. The method of claim 23, wherein said evacuating and flowing steps are performed a plurality of times, with a final flowing step being performed and maintained during operation of the exposure radiation source.

25. The method of claim 20, further comprising the step of redirecting the exposure radiation portion to the detector after the separating step.

26. A method of delivering sub-200 nm lithographic exposure radiation which is generated by a lithographic exposure radiation source for use at an application process, comprising the steps of:
sealing off a beam path of the sub-200 nm lithographic exposure radiation within an enclosure;
preparing an interior of the enclosure for transmitting the exposure radiation such that said interior is substantially free of sub-200 nm photoabsorbing species, and wherein said exposure radiation is directed along a beam path within said enclosure and is thereby protected from being substantially attenuated due to the presence of said sub-200 nm photoabsorbing species, and
wherein said exposure radiation is thereby directed along said beam path within said enclosure and not substantially attenuated by said sub-200 nm photoabsorbing species.

27. A method of delivering sub-200 nm lithographic exposure radiation which is generated by a lithographic exposure radiation source for use at an application process, comprising the steps of:
sealing off a beam path of the sub-200 nm lithographic exposure radiation within an enclosure;
disposing at least one optical element within said enclosure;
preparing an interior of the enclosure for transmitting the exposure radiation such that said interior is substantially free of contaminant species, and wherein said exposure radiation is directed along a beam path within said enclosure and is thereby protected from being substantially disturbed by said contaminant species; and
interacting said exposure radiation with said at least one optical component within said enclosure, wherein said exposure radiation is thereby directed along said beam path within said enclosure and not substantially disturbed by said contaminant species.

28. The method of claim 27, wherein said at least one optical component includes a diffraction grating.

29. The method of claim 28, wherein said interacting step includes the step of dispersing said exposure radiation such that only a selected portion of a spectral distribution of said exposure radiation continues to propagate along said beam path and other portions of said spectral distribution of said exposure radiation are dispersed away from said beam path.
